(19) United States
(12) Patent Application Publication
(10) Pub. No.: US 2014/0147815 A1
(43) Pub. Date: May 29, 2014

(54) FORCE REDIRECTING DENTAL CORE SYSTEM

(71) Applicants: Robert Sicurelli, Syosset, NY (US); Samuel Masyr, Brooklyn, NY (US)

(72) Inventors: Robert Sicurelli, Syosset, NY (US); Samuel Masyr, Brooklyn, NY (US)

(21) Appl. No.: 13/684,522

(22) Filed: Nov. 24, 2012

(51) Int. Cl. A61C 8/00

(52) U.S. Cl. CPC A61C 8/0093
USPC 433/220

(57) ABSTRACT

A prefabricated, hybrid dental pulp organ replacement system has a tube-like core device formed as a substantially cylindrical sleeve formed of a high-strength, high-density material, having a coronal end and an apical end and configured to be partially inserted and fixed at its apical end to a root cavity. The system also has a root device forming a low-density, low-strength volume, including an apical portion formed in an inner volume of a root cavity of a tooth under restoration and a coronal portion extending slightly above a cement-enamel junction of the tooth. The high density core component redirects mechanical forces imposed thereon into a root periphery of a tooth to prevent the forces away from an axial center of the root while protecting the portion of the low density volume surrounded by the jacket from deleterious forces and fluids.

### CROSS-REFERENCE TO RELATED APPLICATION

This application is a continuation-in-part (CIP) application of U.S. patent application Ser. No. 12/592,347, filed Nov. 24, 2009 (“the parent application”) and claims priority from the parent application under 35 USC §120;

### BACKGROUND OF THE INVENTION

The present invention broadly relates to the restoration of endodontically treated teeth, and more particularly relates to a dental core system and a dental core and post system that include a coronal core component comprising a jacketed post articulated to root post component whereby together these parts form a sui generis device or system that interrupts and/or redirects and/or reduces mechanical energy that is imparted both in normal function or in high stress from travelling down the center of the root and distributing same along the periphery of the root, as occurs in normal untreated state.

Dental posts and core systems are widely used to restore endodontically treated teeth to create an adequate foundation to attach a crown. For example, dental posts are fixed to the endodontically treated root then a core is attached to the post. Finally a restoration such as a crown is attached to the post and core system. Generally, a dental post (sometimes referred to as a dowel) is fixed in the endodontically treated root for retention and lateral and vertical stability of the restoration. A core or coronal component provides foundation support for the crown, onlay, etc. The core is usually found above the cement-enamel junction in the crown portion of the restoration, while the post or dowel is located within the endodontically treated canal.

Two general types of post and core systems are known: prefabricated, e.g., made from metal or fibre reinforced composites and custom cast, made from cast metals. Prefabricated posts require an in vivo core to be attached to the post relying on minimal adhesion and mechanical attachment of the core to the post. Metal custom cast posts have the core part integrally attached to the post component as part of the casting. In both of these examples there is direct uninterrupted path for mechanical, vibratory or other and other forms of energy to travel directly through the core and down the center of the post which is attached to the center of the root.

Several significant problems are encountered in restoring endodontically treated teeth, which typically require such treatment due to trauma or neglect. For example, root canal therapy and refinement of the root canal results in a mechanical weakening of the tooth. Once the pulp including blood supply is removed from the tooth's root canal some researchers have demonstrated that the tooth over time becomes more brittle, and is more susceptible to fracture. Moreover the root canal process itself machines away the natural protective “dome” or roof of the pulp chamber of the tooth [see figure b.] that houses low-density tissue and maintained rigidity of the natural tooth while transferring mechanical and other stimuli laterally away from the center of the root.

Endodontically treated teeth are restored with a metal rebar post or dowel, i.e., dental post. Due to the metal post's inherent high density solid structure, it has an effect of transmitting mechanical forces striking the tooth's occlusal surface along its length. In addition to communicating forces, the inherent solid nature also responds to mechanical energy striking the tooth at its occlusal end in what is known as a wedge effect. The wedge effect is a response resulting from the presence of a metal post in the tooth or root center, tending to concentrate stresses and downwardly directed forces induced during normal mastication, resulting in tooth fracture.

Cailleteau, J., et al., A Comparison of Intracanal Stresses in a Post Restored Tooth Utilizing the Finite Element Method, Journal of Endodontics, Vol. 18, No. 11, November 1992, pp. 540-544, report that placement of a rigid metal post within a tooth alters the pattern of stress along the root canal as compared with an intact tooth. Instead of strengthening the tooth, the inserted metal post stiffens the coronal posted section and shifts the flexure point apically. This affects stiffening, causing the non-posted apical portions to deform at the “lost” apex, resulting in a stress increase in the proximate canal wall. Because maximum bending stresses occur in connection with the apex of the post, any inclusions or defects within the canal wall (dentin) proximate the apical end creates stress concentrations that increase the risk of fatigue crack formation. Defects and microfractures introduced during endodontic treatment and post access preparation could become areas contributing to stress concentrations and ultimate tooth loss.

This is exacerbated in view of the fact that traditional dental posts and cores posses the same mechanical properties, e.g. modulus of elasticity, from one end to the other, whether they are metals, metal alloys, or fibre reinforced plastics (FRPs). Even anisotropic fiber reinforced posts or FRPs have one singular and inherent modulus of elasticity for a dynamic force and the angle of that force applied because the post is solid and continuous from apical end into the core.

Various efforts are known to reduce the stresses caused by post and core system treatment, such as described by Cailleteau. For example, German Patent No. DE 3643219 to Weisskircher discloses a post comprising an elastic wire pin with plurality of flexible, radially extending fins along its length. The pin shows a high degree of elasticity due to its wirelike form so that it more readily adheres to the shape of the root canal. But like the prior art, the Weisskircher pin and fins are fixed against the wall of the root canal, and so acts as an energy transmitter communicating weakening stresses and forces into the root.

As described above, forces on the tooth are directly transmitted to the end of the post in metal post systems. This terminus is the primary energy node or stress point in the metal post systems. The transfer or communication of this energy by the metal post causes fatigue and degradation of the root itself due to cyclic vibrations traveling down the metal post that causes micro-fracture in the root and eventual splitting and failure. Numerous clinical studies document that energy transfer down the center of the root results in damage to the tooth structure that is beyond repair, leaving the clinician no choice but to extract the tooth. Destructive action by transmission of destructive forces via metal post systems fractures more teeth than the break-away action of the fiber post systems.

In systems made completely of metals, the coronal area is spared because of the mechanical properties of metals allow energy to travel in a path down the metal post and concentrate in the root at a terminal energy node. This is the result of the molecular structure of the metal transmitting deleterious forces into the center of the root due to their Youngs modulus that is very high in comparison to the tooth.

For that matter, fiber reinforced dental post systems (which were introduced in the latter part of the 1990s), raised expectations that survival rates of teeth endodontically treated with fiber posts would increase. Under the circumstances, the substitution of fiber post systems for the high strength 100% metal dental post systems did help to increase survival rates of endodontically treated teeth. Teeth treated endodontically with fiber posts systems were lost less often because under stress, the fiber reinforced posts fractured or broke free before the tooth fractured from mechanical energy imposed on the tooth.

Please further note, however, that fiber reinforced dental post systems have demonstrated unique flaws and liabilities of their own. That is, while improved post and core device systems comprised of all fiber reinforced post and core materials are known, such systems flex more than metal post and core systems and therefore give way at a portion of the fiber post that is referred to herein as an energy node of the fiber reinforced post (see details below), i.e., at and just above the are where the post enters the root.

In more detail, an energy node is always found in a fiber post above the root at the junction of the clinically coronal area and the root area by virtue of the material itself and the mechanics of forces on it. Stress concentrates above the root inside the fiber post. The weaker fiber reinforced posts fails when its threshold is exceeded saving the root to be repaired again.

FIG. 7B herein depicts a conventional fiber-reinforced post 190 extending out of root 192. As shown, a Force F acts on the post (through a core portion typically surrounding a coronal post portion in a restored tooth). An energy node 191 comprises both a lower section of a coronal part 190a of the post 190 and a (smaller) upper section of an apical part 190b of post 190. Within the energy node 191, an area 194 that is the portion of the post 190 comprising a primary energy stress point. It is this stress point where peak mechanical energy (from biting or grinding) is absorbed into the fiber reinforced post 190. The total vertical height of the peak stress areas in the post above the root has been shown to be about 3 mm, where the part of the post extending below the root level is about 1 mm.

When this type of post and core system fails, the top or coronal part 190a of the post breaks away from the root portion 190b of the post due to the energy stress of chewing or trauma. While the fiber reinforced post absorbs the energy, if it cannot overcome the stress imposed thereby, due to inherent mechanical weakness of the fiber reinforced dental post system, the post fractures. Predictably, substantially all post fractures in these types of systems will be found in the peak energy absorption areas of the post.

This offered a choice instead of all metals systems. This built in safety mechanism allows for the tooth to be re-treated prosthetically because the destructive energy operating to break the fiber post is absorbed and consumed in the fiber post itself causing the breakage of the post instead of being transmitted into the root as with the all metal systems causing the breakage of the tooth root. Therefore, either mechanical energy is absorbed in the fiber post of fiber reinforced systems or transmitted down the center of the all metal post in metal post systems terminating in the center of the root.

These findings are well documented. For that matter, the history of fiber post systems and germane comparisons to metal post systems are found in the following scholarly articles. Al-Omiri, et al., Fracture resistance of teeth restored with post-retained restorations: an overview, Journal of Endodontics. 2010; 36(9):1439-49; Dietschi, et al., Biomechanical considerations for the restoration of endodontically treated teeth: a systematic review of the literature, Part II, Quintessence Int. 2008; 39(2):117-29; Cagidiaco, et al., Clinical studies of fiber posts: a literature review; Int J Prosthodont. 2008; 21(4):328-36.

These fiber post systems are less likely to split the root because the energy is absorbed in the fiber and matrix of the post in this area. The absorption of energy by the fiber post, which results in a reduction in energy (i.e., mechanical forces) traveling down the root, is due to the low modulus of flexibility of the fiber reinforced post. This reduction in energy travelling down the root prevents the root from splitting as in metal post systems but the liability is that post splits instead.

Another problem related to fiber post system is that repetitive vibrations (due to mechanical energy imparted through occlusive forces) cause micro-fractures in the resin or binder of the fiber reinforced post in this energy node area. That is, the primary stress point or node of the fiber reinforced post is weakened due to the degradation of the surface of the fiber due to cycling of vibrational forces traveling down the reinforced post from the top of the post down to the node.

Micro-movement of the fiber reinforced post also causes stress in this energy node area and exposure to fluids causes accelerated breakdown of the fiber reinforced. In more detail, the high energy node area of the fiber post system draws fluids by capillary and pumping action of micromovement of the post. Fluids of the oral cavity cause the root portion to structurally break down both the cement holding the post into the root and the surface of the post itself. The degraded surface then absorbs fluids and softens the fiber reinforced post causing mechanical failure. Similarly, the surface of the fiber post itself is prone to abrasion breakdown due to dental cleaning powders.

Another flaw in fiber post systems is the proclivity for the post to de-bond or loosen from its cemented position in the root due to a lifting moment caused by forces on the opposite side of any applied force to the system. This lifting moment is concentrated in the high energy node area of the fiber reinforced post, and operates as a fulcrum point.

While fiber reinforced post systems are able to protect teeth from chewing and traumatic forces better than the all metal post systems, the aforementioned flaws still result in premature loss of the tooth or in the best case scenario expensive repetitive treatments.

Since their introduction, both metal posts and fiber dental post systems were just that: one material or another, so that dentists had to choose one system with preferred favorable properties along with the inherent flaws of that system. The dentist had to choose between a potentially root splitting metal post that transmitted energy into the center of the root or a stress sensitive fiber reinforced alternative that protects teeth from fracturing by absorbing energy into itself but created a disadvantageous energy node in the coronal part above the root. If the dentist chooses the all metal post system he/she looses the tooth saving properties of the fiber reinforced post system. The all metal systems protected the coronal area but risked splitting the root.

While some post systems are known to include a flange device, for example, devices sold under the trademark “Flexiflange” and others, such post systems are known to be made from 100% fiber reinforced material or 100% metal material. Hence, the respective mechanical properties of such flange-based system by simple laws of physics react identically to those metal and fiber post systems previously described. That is, the flange accoutrements found in either all metal or all fiber post and core systems rest on the surface of the root and provide no protection to the energy node in the core portion. In function and stress the energy node remains just above the flange in these systems because the materials are the same

### SUMMARY OF THE INVENTION

The instant invention provides a dental core and post system and a dental core system, each of which overcomes the shortcomings of conventional dental post and core systems.

The inventive dental post and core system and dental core system of the invention include core devices that attach to or are integrally part of posts affixed to a treated tooth, acting to interrupt and/or redistribute communicated forces that might normally travel along the dental post and fracture a tooth remainder or fracture the post itself.

Put another way, by fixing an inventive core device or core and post device in an endodontically treated tooth, forces applied to the tooth during normal chewing are not transferred along the tooth central axis towards the root as they normally would be in the presence of a conventional metal dental post or dowel. The normal occlusion-generated forces wherever they happen to contact the tooth are interrupted, dampened and/or redirected away from the central axis for absorption in lateral tissue and/or bone, reducing a likelihood of fracture in all metal systems. This invention also prevents a fiber reinforced post system from breaking while retaining its inherent advantages.

As mentioned above, in traditionally restored endodontically treated teeth, the lost volume of the tooth's chamber area is replaced by a solid dowel that is attached to a sold core. In natural teeth the pulpal chamber contains an artery, nerve and vein all composed of low-density tissues, essentially an organ. The inner surface of the pulpal chambers resembles a dome, for example, an arched or geodesic dome, and is made of dentin. This natural structure is machined away during root canal treatment. There is no naturally occurring anatomy which promotes the transmission of forces down the soft, tissue-filled canal, i.e., along the central axis. The inventive systems provide a biologically correct replacement for missing tooth structures removed during the root canal therapy procedure, whereby treatment with same results in an interruption and/or improved distribution of forces and stresses away from the root center in which the dental post resides, by changing the force vector, i.e., the direction of biting forces induced in the treated tooth.

In an embodiment, the novel core device and novel core and post device include inner low-density inner volume portions positioned centrally that replace or mimic the form and function of the missing tooth “organ” in an endodontically-treated tooth. That is, each core device and each core and post device include a low-density inner volume or center through which the central root or post axis passes. This low density inner volume interrupts and/or redirects forces away from the root center, like an untreated vital tooth. The pre-existing qualities and functions of the natural vital tooth prior to endodontic treatment are truly restored from the inside out; occlusal forces are interrupted and deflected away from the central canal of the root, as they would be before the tooth was compromised, i.e., reamed, cleaned, irrigated and obturated.

Low-density volume, as used herein should be understood to mean that the net density of the low-density volume is lower than the density similarly located volume in traditional prefabricated devices because traditional prefabricated devices are made from one piece of solid metal, solid metal oxide or solid fiber reinforced composite and have no inner volume. Low-density material has a lower density than tooth structure and a lower density of traditional metal alloys used in dentistry. For example, a low density material as used herein should have a density value in grams per cubic centimetre (g/cu. cm) in a range between 0.0 and 2.05. This range includes materials such as bonding agents, cements, resins, impression materials, monomers, pit and fissure sealant, some composite resins, silicate, vitreous carbon and air. For example, Silux enamel bond (1.20 g/cu. cm) is a low-density bonding agent. Cements can be low density including calcium hydroxide, e.g., Dycal (1.91 g/cu. cm), dentin cement (2.02 g/cu. cm), Resin, for example, CBA 9080 (2.02 g/cu. cm), unmodified ZOE, e.g., Cavitec (2.05 g/cu. cm).

Low density impression materials (polymerized) include polyether, e.g., Impregum (1.06 g/cu. cm), silicone (addition), e.g., Baysilex (1.37 g/cu. cm), Provil medium (1.40 g/cu. cm), high (1.43 g/cu. cm). Low density monomers (crown-and-bridge resins) include methyl methacrylate (0.9374 g/cu. cm), ethylene glycol dimethacrylate (1.055 g/cu. cm), 1, 3-butylene glycol dimethacrylate (1.02 g/cu. cm), triethylene glycol dimethacrylate (1.072 g/cu. cm) and low density pit and fissure sealants include Delton (1.23 g/cu. cm). Low density restorative materials include composite resin, e.g., all-purpose heliomolar radiopaque (1.84 g/cu. cm), anterior Silux Plus (1.61 g/cu. cm) and Silicate improved filling, e.g., porcelain (2.01 g/cu. cm). Low density materials further include tooth structures such as cementum (2.03 g/cu. cm), vitreous carbon (1.47 g/cu. cm) and water (1.00 g/cu. cm Silicone and polyurethanes set by chemical or light would also work well as a low density material for these innovative devices.

In the embodiment, the core device comprises a hollow, semi-spherical high-density shell. The shell is configured as a supporting dome or crown for fixation to a coronal portion of a dental post or dowel. A vertical axis of the core device/post passes through the hollow, albeit low density inner volume. Because of its hollow nature, vertical or downward traveling forces and energy resulting from occlusal contact cannot pass directly through the core device along the vertical axis, but are interrupted and redirected so they do not pass through the core device to the top of the post. Put another way, the low-density discontinuity disrupts the downward flow of mechanical energy, preventing damage to the root from same downwardly directed forces and or downward push of the post.

The hollow core device may comprise a dental core system, wherein the core device is configured to be affixed to the coronal portion of the dental post in vivo.

The hollow or low-density dome (i.e., core device) or hollowed coronal post portion may be formed in shapes that correspond to a space for which treatment needs to cover. For example, a tooth for restoration might have 50% of its dome or crown structure remaining, such that full core device might not fit. The invention addresses this issue in a core system comprising a core device sized or shaped as a half moon or quarter moon.

In an alternative embodiment, the core device may be manufactured in such a way that it is integrally part of a dental post. In an alternative embodiment to such a dental core and post system, the integrally formed dental post may further include an inner low density volume that is contiguous with the inner low density volume of the core device. That is, both the core device and the dental post may comprise a hollow or low-density portion. In either case, at least a portion of the dental post is cemented into the root, or tooth remainder.

In another embodiment of the dental core system, and the dental core and post system, the core device is arranged with splines or ribs that extend away from a high density portion of the core device, e.g., shell, to effect a redirection of downward induced occlusal forces. Preferably the affixed splines or ribs extend from the core device and are affixed to a remainder portion of the tooth structure, which thereafter acts as a sink to redirected mechanical energy. While the splines act to redirect the mechanical energy away from the central axis (of the core device and/or post device), regardless of whether the core device comprises a low density inner volume as described above, it is preferable that the core device to which the splines are connected includes the low density inner volume. In that way, there are two mechanisms which act to redirect forces traveling downward from occlusal contact.

Moreover, various embodiments of prefabricated core devices are formed to fit tighter spaces, e.g., or variable shapes of remaining tooth structure. For example, a dental core device embodiment includes that splines extending down from the core device mimic ribs extending from a ferrule of an umbrella. Upon insertion, the splines or ribs are spread out to open partially. That is, the umbrella-like core device could be cranked open or closed in vivo depending on the volume of tooth structure lost. The inventive core device and its splines may be assembled in vivo, and attached to a traditional post. For that matter, the core device may comprise just the splines or ribs, which are fixed both to the post and to a tooth remainder to form a solid path by which mechanical energy is directed away from the post into the remainder tooth structure or dentin.

Preferably, the core device contains a means of or mechanism at its end that its occlusal end to facilitate attachment to a dental post For example, the core device can be configured with an opening into which the post may be inserted, e.g., so the coronal post portion slides or snaps into place. In this case, post might be manufactured with ball-like top at its coronal end, where the ball-like top snaps or is otherwise fixed into a complementary space in the core device. Such novel core device can be part of a core system, sold for use with conventional dental posts, or as a part of a dental post and core system, where the core device is manufactured as an integral part with the dental post. For that matter, there may be one or more through holes in the sides or apical center of the attachment or coupling means, to allow for low density material or adhesive to flow through it and envelope the dental post in vivo, or to flow into an opening or inner volume in the coronal end of a dental post comprising one embodiment of a dental core and post system, described in greater detail below.

An alternative attachment means for attaching a core device to a dental post is configured with a cylindrical portion to slide over and attach the coronal end of the dental post in vivo. The inside diameter of the cylindrical portion is larger that an outside diameter of the dental post. This cylindrical portion is preferably configured as a crimpable cylindrical shell in order to securely attach to the coronal post. The attachment means, however, is not limited to attachment merely by crimping. The attachment means may be attached to the dental post with a traditional low and/or high density adhesive, with or without crimping. Another variation of this attachment means is construction where an inside diameter of the cylindrical portion has a slight taper to mate with that of the coronal aspect of the post. In all cases this means of attachments functions to discontinue, redirect and dissipate energy away from the center of the canal acting as a buffer

The core device may be manufactured so that the attachment means is integral with it, for example, in an extrusion process or an injection molding process. In that way, the attachment means portion of the core device is configured to extend out from a hard shell of the core device for attachment to the dental post. Alternatively, the attachment coupling means may be constructed as a separate device configured to be fixed to the apical end of the core device using an FDA approved adhesive at manufacture, or constructed as a separate standalone device for connection both the core device and the dental post at use.

Alternatively, the core device or dome may comprise a wire frame or cage, defining its shape and a portion of the core device structure to contact the dentin. The higher density wire frame provides a skeleton to house the low-density material within. As such, force striking the top or occlusal portion of the core device would travel along the shell, i.e., cage and make contact with and communicate into the dentin rather than pass along the central core/post axis. Preferably, such a cage-like core device (or dome structure) comprises a low-density volume. The low-density volume, whether comprising a core device attached to or integral with a coronal end portion of a dental post, with or without an inner volume or post channel, preferably includes a low-density material, e.g., air, which defines the density of the low-density volume. It is important to distinguish the means of attachment of the two sections described in this new device from all other solid one piece post and core devices where the coronal part and root parts are manufactured from a solid piece of metal or fiber reinforced composite. The means and material used for attachment of the two sections here provides a low density buffer to redirect, alter or buffer energy transmission. The other devices in the prior art provide a continuous energy path because the core device or coronal component is constructed together and contiguously, that is connected without a break, to the post component

Alternatively, the novel core and post system may comprise only a wire-formed core device and top post portion, forming a hollow inner volume extending contiguously from the core device into the top portion of the post device. This low-density inner volume is filled with a low density material, e.g., air or resin, and provides the low-density discontinuity along the vertical root canal axis, and redirects forces via the wire frame. The redirected forces are absorbed by the dentin surrounding the canal space and/or the residual walls of the tooth. This significantly reduces stresses including the above-mentioned wedging effect, and therefore, likelihood of tooth fracture. That is, damaging and material fatiguing forces are redirected away from the center of the root, with respect to the tooth axis, which would be inherently destructive.

In another embodiment, the invention provides a hybrid dental post system that is a marked improvement over both the traditional metal post system and fiber reinforced post system. The hybrid dental post system includes the best features of both the traditional metal post systems and fiber reinforced post system without their limitations. i.e., a fiber reinforced root portion and a jacketed high strength core portion positioned to exhibit advantageous respective mechanical properties where they are needed most. The innovative juxtaposition of these two diametrically different elements creates a new device with improve properties.

The jacketed core part of the hybrid dental post and core system surrounds the inner fiber reinforced post in the coronal end of the tooth. The unjacketed apical portion of the post extends into the root area. The jacketed core portion of the system may include a platform-like portion just above the tooth root. The jacketed core portion is secured to the inner fiber post by low density cement or mechanically attached. The jacketed core portion is preferably formed by metal or metal oxide, but may comprise any rigid, high density structural material without deviating from the scope or spirit of the invention. The platform or jacketing is attached to the tooth remainder or root the fiber reinforced post that is in the root area. Accordingly, forces that might normally traverse the vertical extent of the tooth, from the biting surface through the root, are redirected to the tooth remainder and not down the center of the root. The jacketed area of the fiber post is protected from fracture thereby and conditions that might otherwise operate to affect an uncladded (or non-jacketed) fiber post are accommodated. Patients, therefore, receive the benefits of a fiber post without its flaws.

Benefits of the hybrid dental post system include that the metal jacketing about the upper core portion or extension of the post operates to protect the post, to strengthen the coronal or core portion and protect the post from moisture and corrosive elements, which then helps to prevent de-cementing of the post itself. An upper post portion clad in an outer high density jacket with a fiber reinforced apical root portion separated by a low density volume are not found in systems in the prior art. As mentioned, prior art posts are known to be made of singular materials whether composed of all metal or all fiber reinforced composite.

In an embodiment, the hybrid dental post system includes a spline or any of a series of splines attached to the jacketed coronal portion. These splines (or projections) are integrally attached to the jacket and made of the same high density high strength material. The spline or splines may be adapted in vivo to fit on the root or into the missing areas of the root that were lost due to decay or trauma. For example, a spline may be positioned in an existing groove or slot on the tooth root or a slot that is machined grooved.

It is unnatural for forces to be transmitted down the center of teeth because the higher density enamel shell in the coronal or crown part of the tooth (sometimes referred to as a “dome”) is hollow and filled with pulp tissue composed of low density vein, artery and nerve tissues. This “dome” communicates directly with the root (sometimes referred to as a canal), within which the hollow area becomes increasingly narrower as the terminus of the root is approached. The jacketed coronal portion (covering the upper post) operates to communicate energy from the coronal area of the tooth to the periphery of the root and not down the center. The low density pulp tissue acts as a shock absorber and the high density enamel acts to transmit energy away from the center. Putting any type of post into the canal space is unnatural and changes the energy transmission dynamic of the root. This innovative device allows a post to be used to restore a tooth in the most natural way possible.

The jacketed component or platform mates with the post to prevent rotation. This mating is improved by creating flat surfaces on both parts that line up in both vertical and horizontal dimensions. These could be facets, détentes, tapered cylinders tube and sleeves, slip joints and so on.

### DESCRIPTION OF THE DRAWING FIGURES

Aspects of the disclosed technology will become apparent upon reading the following detailed description and upon reference to the accompanying drawings in which, like references may indicate similar elements:

FIG. 1A depicts one embodiment of a dental core and post system of the invention;

FIG. 1B depicts another embodiment of a dental core and post system of the invention;

FIG. 1C depicts a variation of the FIG. 1A embodiment;

FIG. 1D depicts a variation on the FIG. 1B embodiment;

FIG. 1E depicts a another embodiment of a dental core and post system of the invention;

FIG. 1F depicts a top cross-sectional view of the FIG. 1E dental core and post system at an interface between the core device and post;

FIG. 1G depicts another embodiment of a dental core and post system of the invention;

FIG. 1H depicts a downward looking cross-sectional view of the FIG. 1G dental core and post system;

FIG. 1I depicts a an embodiment of a dental post (38) seen in cross section and including a slot or inner channel;

FIG. 1J depicts a modified or alternative version of the FIG. 1I dental post;

FIG. 2 depicts another embodiment of a dental core and post system of the invention;

FIG. 3A depicts another embodiment of a dental core and post system of the invention;

FIG. 3B depicts another embodiment of a dental core and post system of the invention;

FIG. 4A depicts one embodiment of a dental core device of the invention;

FIG. 4B depicts a plan view of the snap-on core device to highlight the snap-on end;

FIG. 4C depicts an alternative embodiment of the snap-on core device depicted in FIGS. 4A and 4B;

FIG. 4D depicts an alternative embodiment of the snap-on core device depicted in FIGS. 4A, 4B and 4C;

FIG. 4E depicts a strut-like core device attached to a post;

FIG. 4F depicts an alternative embodiment of the dental core device depicted in FIG. 4A;

FIGS. 5A and 5B together depict another embodiment of a dental core system of the invention;

FIG. 6A depicts_another embodiment of a dental core system of the invention;

FIG. 6B depicts the expandable core device of FIG. 6A;

FIG. 6C depicts the expandable core device of FIGS. 6A and 6B in an expanded state;

FIG. 6D depicts an alternative embodiment of the dental core system of FIG. 6A including a skin surrounding the expandable core device in an expanded state;

FIG. 7A depicts an unjacketed fiber reinforced post commonly used in dentistry;

FIG. 7B depicts an energy node in a conventional fiber-reinforced post extending out of a root and acted upon by a Force F;

FIG. 8A depicts one embodiment of a hybrid dental post system of the invention;

FIG. 8B depicts an alternative embodiment of a dental post system of the invention;

FIG. 8C depicts inner cylindrical surface of the jacket 220B′ in sleeve part 224, which contains a connecting means 216 for mating with corresponding detent means 217 of fiber reinforced post 215′;

FIG. 9 depicts one embodiment of a jacket for attachment to the upper coronal end of the fiber post or dowel, in vivo;

FIG. 10A depicts one embodiment of a jacket formed as a tapered cylinder for attachment to the upper coronal end of the fiber post or dowel, in vivo;

FIG. 10B depicts the embodiment of FIG. 9A with through hole from the outside jacket surface to the inner cylindrical volume surrounded by the jacket;

FIG. 11 depicts one embodiment of a jacket formed with a cylindrical stabilizing extension, which extends into the root and attaches to the portion of the fiber post thereat;

FIG. 12A depicts one embodiment of a jacket for attachment to the upper coronal end of the inventive dental post system that includes 4 splines extending from the radial center for fixation to portions of the tooth remained;

FIG. 12B depicts a perspective view of the FIG. 12A embodiment;

FIG. 13A depicts a side view of an embodiment of a jacket 220G made of alumina oxide ceramic;

FIG. 13B depicts and alternative form of the embodiment of FIG. 13B;

FIG. 14A is a perspective view of an embodiment of a jacket 220I with at least one inner cylindrical bore or barrel; and

FIG. 14B is a cross-sectional view of the FIG. 14A embodiment;

### DETAILED DESCRIPTION OF TEM INVENTION

The following is a detailed description of example embodiments of the disclosed technology depicted in the accompanying drawings. The example embodiments are in such detail as to clearly communicate the disclosed technology. However, the amount of detail offered is not intended to limit the anticipated variations of embodiments. On the contrary, the intention is to cover all modifications, equivalents, and alternatives falling within the spirit and scope of the invention, as defined by the appended claims. The descriptions below are designed to make such embodiments obvious to a person of ordinary skill in the art.

Natural, vital human teeth have only low-density soft tissues in the chamber and root, i.e., pulp with blood vessels and nerve tissue. The natural top of the chamber, or crown, comprises a shell of enamel enveloping a dentin layer about the upper chamber with pulp, etc. The natural crown and root so formed is designed to deflect and redistribute mechanical energy and/or forces traveling down the tooth resulting from occlusal contact. That is, biting forces do not normally travel along or within the root canal of a vital tooth but rather along the tooth's sides. The same is not true, however, with endodontically treated teeth restored with dowels and traditional core materials, whether prefabricated or custom cast.

As mentioned, traditional dental posts and core devices are solid and fixed to the internal surfaces to the center of the tooth's root, forming a contiguous solid structure. Such contiguous solid structure begins at the occlusal end of the tooth and extends to the apex of the root. Because prefabricated dental posts used with conventional core systems to fill the missing chamber and root are constructed of solid metal, fibre reinforced composites or plastics (i.e., high density materials), they cannot replace the function of the low density soft tissue present in vital teeth, pre-restoration. That is, the removed low density tissue, and therefore, low density volume results in marked inability of the restored tooth to shield the canal space from operating act a pathway to external forces traveling down and substantially along the tooth/canal center, i.e., occlusal or chewing forces.

The core devices of this invention are designed restore an endodontically treated teeth while maintaining t the natural function of those teeth prior to having endodontic treatment by mimicking the force redirecting dynamic found in natural teeth. The invention may comprise a dome or core device affixed to and/or formed with a vertically extending post structure, where at least one of the dome/core device and post structure is configured to include a low-density volume. Preferably, the low-density volume is filled with a low-density biocompatible material, such as air, settable foam, or low-density resin.

The low density volume acts to inhibit and/or forces traveling along the dental post in a restored tooth within which the core device is used. The redirected forces are dispersed and absorbed into the dentin and/or residual enamel, the soft tissue surrounding the crown and the bone surrounding the root, avoiding any solid post or dowel fixed therein. That is, this low-density character of the inner core device volume mimics the natural vital tooth construction to buffer or interrupt and redirects biting forces away from the affixed post.

In an embodiment, the dome or core device may comprise a spherical or semi-spherical structure with an inner volume or center that is hollow or semi hollow, i.e., air filled. Such inner volume also may be pre-filled with a low density material at a time of manufacture or in vivo by the dental practitioner at the time of treatment including placement or fixation of at least part of a dental post into a root canal. In the latter case, the core device will include an opening, preferably at the top, to facilitate filling and or fixation of the device to the root (where the low-density material is a dental adhesive or cement). A vent is includes to allow pressure release at filling where needed, which filling is typically carried out with a syringe-like device.

Alternatively, a dental core device may be configured to snap on to a traditional dental post or dowel, may include a recess in the bottom into which a coronal end of the dowel extends, or may include a cylindrical member extending down from the apical end of the device which surrounds some portion of a top or occlusal end of the dowel. Other core devices may be designed merely to contact the occlusal post end, where a device portion is fixed to a tooth remainder either directly, or though one or more splines or ribs. In one embodiment, a diameter of the core device which contacts the tooth root may be adjusted radially where it will create a continuous mechanical path away from the post device to which it is in physical contact.

This mechanical path created by the core device will direct or redirect vertical or and angular off-vertical forces away from the root center. For that matter, the core device may be connected to a conventional dental post using any means known in the art for making such connection, and may be attached at any point along the vertical length of the dental post, while preferably at its occlusal end. Depending on the tooth, and the intent of the dental professional attaching the post and core device, multiple splines may be attached to the post and fixed to the tooth structure at various radial positions relative a central vertical post axis.

The dental core system and dental core and post system, in addition to a core device such as described, may further comprise a dental post with an open lumen (i.e., inner volume) configured along some portion of its length, preferably along a top portion proximate its occlusal end. This inner volume, however, is not limited to be about ⅓ of the post length, but may be greater or lesser that ⅓ as long as it does not extend completely to the apical post end. Preferably, the post inner volume or lumen is contiguous with an open inner volume of the core device attached or manufactured integrally thereto. The inner volume(s) of the core device and/or post comprise low-density material, either manufacturer filled of filled at fixation by the dental practitioner, where the core device and/or post would include a via though the post shell or wall to allow for in vivo filling with the low-density material.

In an alternative embodiment, the core device includes a plate or disk-like structure that is large enough to cover an open lumen or low-density volume of the dental post. The plate is manufactured with a via through which the dental post is passed or slid through, and which functions to limit lateral movement of the post when striking forces by transferring energy to the residual tooth structure surrounding inner volume portion. The plate could be attached to the dental post rigidly at manufacture, or be available as a separate plate or disc for fixation to the post at the time of treatment. For that matter one or more additional plates could be positioned between the plate and coronal end of the dental post.

Moreover, while each of the core device and core device with dental post are preferably integrally formed as one piece (for example, the inner volume and solid lower portion of the dental post portion), the components also may be formed separately and made of different materials. For example, the core device or dome and post portion surrounding its inner volume may comprise a hard high density plastic, metal east or wire cage shell, the lower post portion may comprise a solid metal or fibre-reinforced composite, or a volume of low density plastic, foam or filler without limitation.

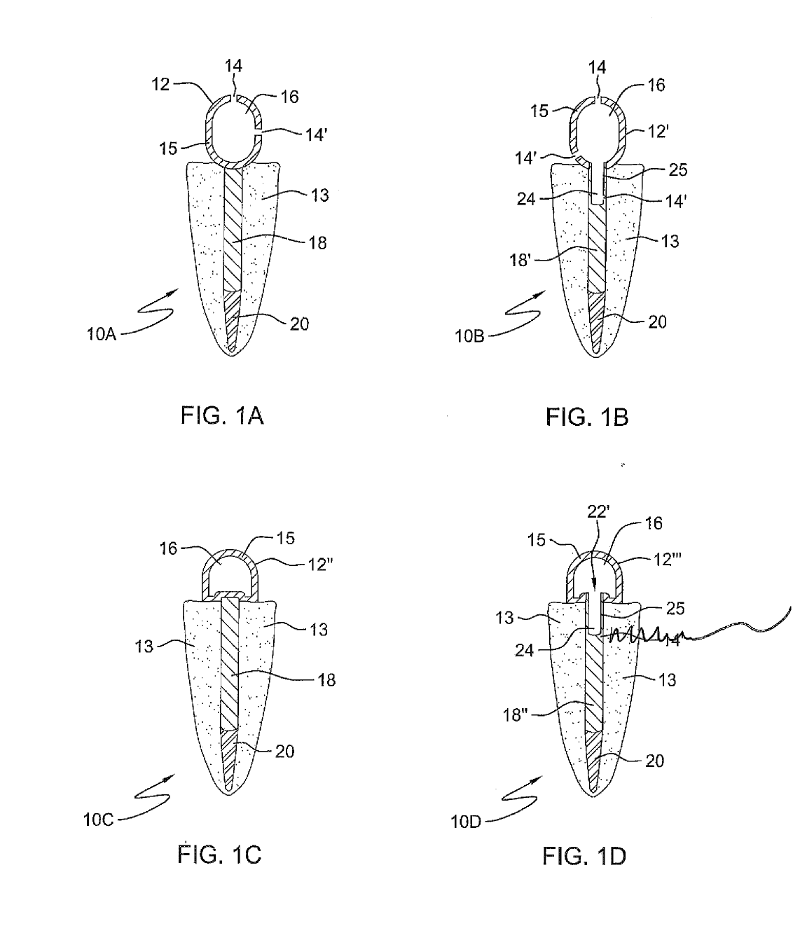

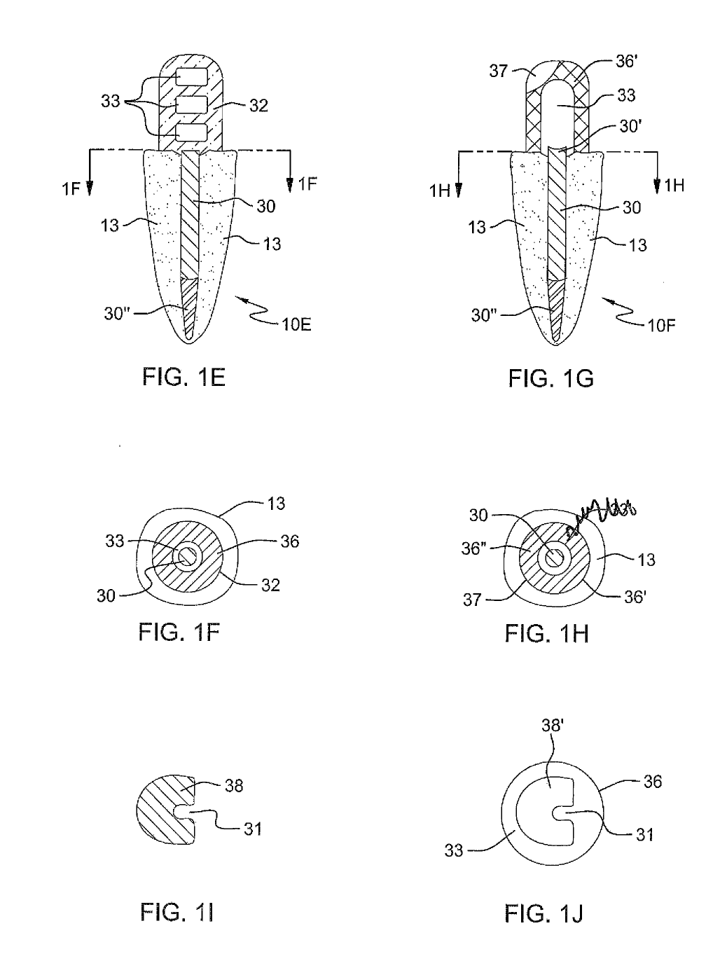

FIG. 1A depicts one embodiment of a dental core and post system (10A) that comprises a spherical core device (12) formed with an opening (14) in a shell (15) to enable a hollow center (16) of the core device surrounded by the shell (15) to be filled with a very low-density settable material at fixation. Shell (15) preferably comprises a high density material, in order to maintain its shape, i.e., the shape of the inner, low density volume. While not shown in the figure, the core device (12) may be filled through opening (14) of shell (15) using any means known to the skilled artisan, for example, a syringe-type tip through which the low density material will flow. Preferably a vent (14′) is included in the shell (15) to release pressure as the core device is filled.

And while the core device (12) is depicted as spherical, the core device is not intended to be limited to a particular shape as long as at least some portion of an inner volume is found in a path from its top to bottom along its axial center in order that it prevent communication of vertical or downward traveling forces and energy resulting from occlusal contact. For that matter, while the core device (12) is shown attached to a post (18), the core device and post may be separate devices connected at the time of treatment. The core device (12) may be connected to post (18) using any means known to the skilled artisan, for example by including an indent to receive a coronal end of the dental post, by adhesive or cement, crimping, etc.

That is, the FIG. 1A dental core and post system (10A) further comprises a solid vertical post member or dowel (18) and a lower post portion (20). The dental post (18) is shown surrounded by tooth root or root material (13), e.g., dentin, where some portion of the outer shell of the core device contacts and/or is affixed to the tooth remainder. Upon fixation filling the inner volume of core device (12), the material is set/cured and openings (14; 14′) in shell (15) are sealed. It should be noted that the shape of core device (12), the dimension of the inner volume (16), the size and location of the openings (14; 14′) in shell (15), the length, diameter and taper of the vertical post member (18) and any attached lower post portion (20), or alternatively, gutta percha, may vary without departing from the spirit or essence of the invention.

That is, the only requirement is that the core device of the dental core and post system include a low-density inner volume to act as a discontinuity between at high density crown surface and a lower density post to redirect or inhibit downward communication of mechanical energy generated by occlusal or biting forces passing along the vertical center of the post/root canal after fixation. This discontinuity between the core device and post further acts to prevent forces that might act to dislodge and downwardly move a solid post positioned directly under the core device, which forces might otherwise split or fracture the tooth remainder or canal.

FIG. 1B depicts a dental core and post system (10B) that represents a variation on the FIG. 1A embodiment. That is, dental core and post system (10B) includes an opening at a lower portion of a shell (15) to facilitate fluid communication between the inner volume of the core device (12′) with an inner volume or lumen (24) included that is part of the dental post positioned above the solid vertical post member portion (18′). Inner volume (24) of the dental post is surrounded by shell portion (25). After fixation in vivo, filling with low-density material, and sealing, the low-density inner volume of core device (12′) and the low-density inner volume or lumen (24) forming an occlusal end of solid vertical post (18′) together act to prevent the communication of downwardly flow of mechanical energy initiated by biting contact through the axial center of the tooth, including the solid post portion. As, such the wedge effect is substantially minimized. Vents (14′) are shown in both the core device shell structure (15) surrounding the low-density inner volume and the shell portion (25) enclosing the post lumen (24).

FIG. 1C depicts a dental core and post system (10C) that represents a variation of the FIG. 1A embodiment. That is, dental core and post system (10C) includes a core device (12″) with an inner volume (16) surrounded by shell (15) and pre-filled with a low-density, preferably biocompatible, material. There is no need for an opening (14) or vent (14′) because dental post and core system (10C) is pre-filled. The core device (12″) is shown seated upon or otherwise contacted with remainder tooth or root structure (13), and further contacting or attached to an occlusal end of post (18).

FIG. 1D depicts a dental core and post system (10D) that represents a variation of the FIG. 1C embodiment. Dental core and post system (10D) includes a core device (12″′) with inner volume (16) surrounded by shell (15), which is pre-filled with the low-density material. Post device (18″) includes an inner shell portion (25) surrounding an inner volume or lumen (24) of vertical post portion (18″). An opening (22′) in shell (15) and interfaces with an opening in shell (25) of inner volume (24), whereby the respective volumes merge to form a contiguous large inner volume in the core and post system. Like core system (10C), there is no need for an opening (14) because dental core and post system (10C) is pre-filled.

As a means for attaching a core device to a dental post, the invention includes an attachment means configured with a cylindrical portion to slide over and attach the coronal end of the dental post in vivo. The inside diameter of the cylindrical, apical end of the attachment means is larger that an outside diameter of the dental post. This cylindrical portion is preferably configured as a crimpable cylindrical shell in order to securely attach it to the coronal post end. The attachment means, however, is not limited to attachment merely by crimping. Another variation of this attachment means is constructing the inside diameter of the cylindrical portion to have a slight taper to mate with that of the coronal aspect of the post.

The attachment means may be attached to the dental post with a traditional low and/or high density adhesive, with or without crimping. For that matter, there may be one or more through holes in the sides or apical center of the attachment means to allow for low density material or adhesive to flow through it and envelope the dental post in vivo, or to flow into an opening and inner volume of a coronal end of a dental post. In all cases the means of attachment functions to, discontinue, redirect and dissipate energy away from the center of the canal acting as a buffer.

The core device may be manufactured so that the attaching means and cylindrical shell is integral with it, for example, in an extrusion process or an injection molding process. In this case, the attachment means is configured to extend out from a hard shell of the core device to form a cylindrical shell to attach to the dental post. Alternatively, the attachment means may be constructed as a separate device configured to be fixed to the apical end of the core device using an FDA approved dental adhesive at manufacture, or constructed as a separate standalone device for connection both the core device and the dental post at use.

In another embodiment, the novel post included with the novel core and post system is formed entirely of composite material the physical properties of which are modified along its length, including the core device portion. For example, the properties of the post material are modified by selectively manipulating the composite material found in the post inner volume (24) and the core device inner volume (16). Where the dental post and core system is pre-formed, for example, by injection molding, multiple molding steps could be used to impart variable shapes and mechanical properties to the posts by layering and used in insert injection molding techniques, for example, the density of the post may be modified to meet practical needs.

FIG. 1E depicts another embodiment of a dental core and post system 10E, where FIG. 1F shows a top cross-sectional view of same at an interface between a core device (32) and post (30). Dental post (30) is shown positioned in a canal within root or dentin material (13) comprising a tooth remainder, which includes a lower portion (30″), for example, gutta percha. The figure highlights an internal volume (33) of the core device (32), acting as an upper coronal portion of the dental core and post system post 10E. Core device (32) is shown to be contiguously disposed upon a rim or ridge of the remaining tooth material or dentin (13). The downward looking cross-sectional view of FIG. 1F depicts the coronal portion or tip of the post (30), upon which is disposed core device (32). The core device (32) is shown to comprise shell structure (36) surrounding low density volume (33). The shell (36) sits upon or is attached to partially obscured tooth remainder or upper most portion of dentin (13).

FIG. 1G depicts another embodiment of a dental core and post system of the invention, where FIG. 1H shows a downward looking cross-sectional view of same. Dental post (30) is shown positioned in a canal within root or dentin material (13), including a lower portion (30″), for example, gutta percha, and an upper coronal portion (30′) extending only partly into core device (36′). Upper coronal portion (30′) of the dental post is shown encased in a core device (36′), just below inner space (33). Core device (36′) is disposed (at least partly) upon a rim or ridge of remaining tooth material or dentin (13). The cross sectional view of FIG. 1H depicts the coronal portion or tip of the dental post (30′). The figure highlights that low-density inner volume (33) is bounded by a cage-like shell structure (36″), upon which is formed an outer skin or surface (37), partially shown. The core device (36′), inner volume (33), shell structure (36″), skin (37) and inner volume (33) sit upon the dentin or tooth remainder (13), and receive a small part of the length of post (30).

FIG. 1I depicts an embodiment of a dental post (38) seen in cross section, including a slot or inner channel (31). Slot or inner channel (31) preferably is positioned at the top or coronal end of the dental post (38), and is configured to receive a protruding member of a core device (not shown), for engagement with the slot to attach the core device thereto. FIG. 1J depicts a modified or alternative version of the FIG. 1I dental post, which is hollow at least at a top or coronal end as shown. For that matter, dental post (38′) is shown surrounded in cross section by an inner volume (33) of a core device (36), comprising a low-density material, e.g., cement, acting to attach the core device to the dental post (38′).

The reader should note that while FIGS. 1I and 1J depict that the dental posts (38, 38′) include the slot to facilitate attachment of a core device, or low-density material, the invention is not limited to such an arrangement for connecting or attaching the post and core device. That is, the core device may be formed with an inner channel or slot device, wherein the dental post would then comprise a protruding portion to mate therewith without deviating from the scope or spirit of the invention.

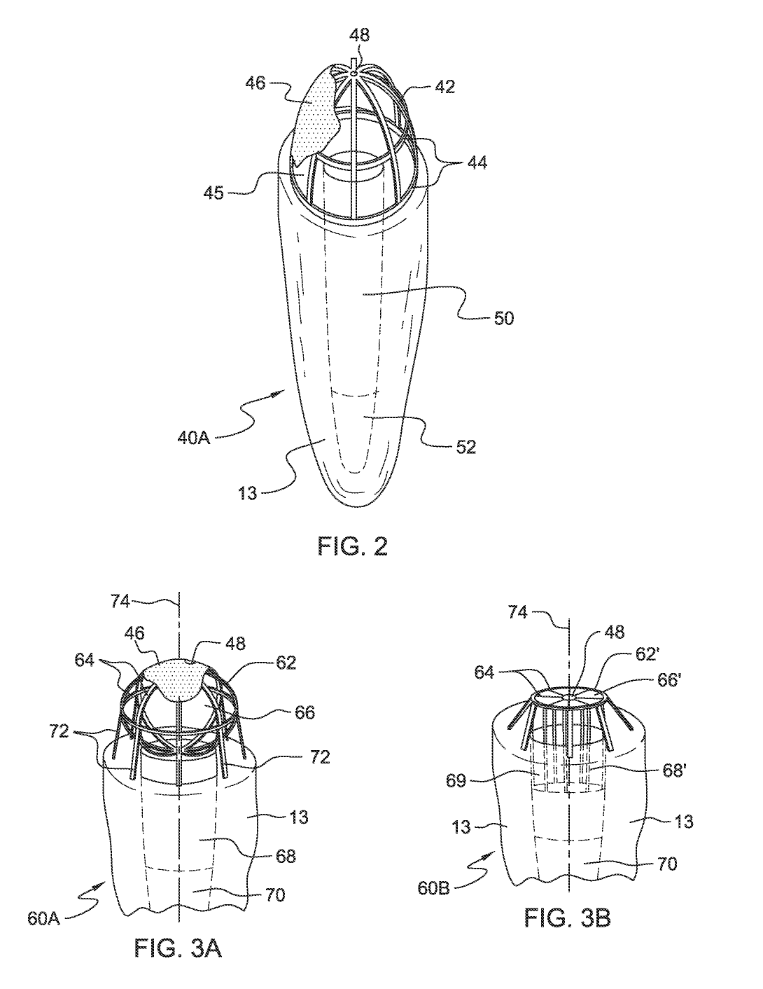

FIG. 2 depicts an alternative dental core and post system 40A configured in accordance with the invention. Dental core and post system 40A includes core device (45) that comprises a frame structure configured from vertical struts or wires (42), as shown. Rings (44) are included to provide structural integrity to cage-like frame or shell structure (45), defining an outer boundary of an inner volume (33). The core device (45) of dental core and post system 40A has an “egg beater” appearance. The inner volume surrounded by the cage-like frame or shell structure (45) is intended to be filled in vivo, so includes a skin, or material containing layer (46). The containing layer (46) may be adhered to the frame (rings (44) and wires (42)), using known processes, such as injection molding, or may simply comprise a sleeve.

The core device (45) is configured to sit upon a remainder tooth portion (13), shown surrounding a dental post (50) with an attached lower portion (52). Such core device (45) design may appear as a fully open, operating parachute, with the substantial portion of the post between the core device and terminus comprising converging extensions. Alternatively, the core device may be solid comprising materials such as dental metals, plastics, reinforced plastics, or composites or combinations of materials, and the middle vertical post length may comprise the low-density material, or to be filled with same at the time of implantation to facilitate interruption of forces directed therethrough.

To fill the skin-enclosed volume defined by frame (45) and skin (46), an opening (48) is maintained at top ring (44). A low-density, preferably biocompatible material is injected into the inner volume, as well as any further material required to set/cure the low-density material. The opening is then sealed by the material when it sets. Preferably, a vent is included to release pressure as the material is filled. In a variation, the dental core and post system 40A may include that the core device (45) is pre-filled with the low-density material during its manufacture, obviating a need to maintain an opening (48) and/or vents. The skin could be removable and used only to compress the inner low-density material in vivo.

The core device construction is such that it communicates downward forces, if at all, at an acute angle relative the root axis away from the attached post and into the dentin or remainder tooth material. The acute angle is preferably greater than 15 degrees but less than 75 degrees, the latter limitation intended to minimize radial forces which might fracture horizontally. Moreover, while each of the vertical post lengths are depicted as tapered, so far, they may be cylindrical with a constant radius extending the along an axial length of the post without deviating from the spirit or essence of the invention.

Alternatively, the core device may be configured with detents or undercut areas to lock in cement. That is, the core device itself could contain holes or perforations in its outer surface to increase retention of cement and reduce mass. For that matter, the outer concave viewing from underneath looking up from the canal. Surfaces could also contain irregularities to provide extra surface area for bonding adhesive or core material. Various surface treatment materials such as, but not limited to, silane may be optionally used to enhance the bonding of restorative material.

In another embodiment, the internal aspect of the core device and the mid vertical post extension into the tube area where the extensions converge could be left hollow or filled in vivo using different materials to achieve different mechanical properties. These fillers could be known dental cements or new creations that match pulpal tissues in density and other properties. The result is a static device with multiple mechanical properties because it was constructed from at least two types of materials. The hollow area could be changed in volume by adding more or less filler of different properties. Also, another embodiment contains a stiffener rod that extends down through a port at the top of the core device and through the hollow into the root aspect. The length and extension and properties of this rod could be changed to the clinician's requirements.

FIG. 3A depicts another dental core and post system 60A, configured in accordance with the invention. Dental core and post system 60A comprises a core device (62) frame constructed from wires (44) in a cage-like form with an opening (48) in a skin or outer layer (46). The core device is filled with a low-density material through opening (48) with any means known to the skilled artisan. Preferably, a vent is included in a shell of the core device to release pressure as it is filled. After set/curing, the openings are sealed. In a variation, dental post and core system (60A) may be pre-filled with low-density material, obviating a need for injection and curing by the dental practitioner, and a need for openings (48). The core device is attached in vivo, or formed as a single contiguous unit with a post (68). Post (68) is shown to include a second, middle portion (70). The post and middle portion may comprise metal, fibreglass, plastic, composite, rubber, gutta percha or like material. A modification of this embodiment includes a sliding or rigidly attached plate that rests on the outer rim of tooth structure surrounding the canal opening.

The core device or upper post portion (62) is configured with extensions or splines (72) extending downward and radially at an acute angle to the post axis (74). These splines or extensions (72) are configured to be fixed to the remaining tooth or dentin (13) to better support the dental core and post system 60A, and to better communicate and disperse downwardly communicated energy and vibrations resulting from biting (occlusal) contact with the tooth away from the post and/or root axis (74). Dental core and post system 60A, therefore, not only includes the discontinuity of the low-density volume (66) comprising core device (62), but also these splines to redirect the downward forces. For that matter, the splines or extensions (72) are preferably frangible, so the dental practitioner can readily adjust their length, at their various locations about the post outer circumference. The characteristic is advantageous in order to allow the dental practitioner to accommodate the shape of the remaining tooth structure into which the dental core and post system 60A is inserted.

FIG. 3B depicts a dental core and post system 60B, that is a variation of the FIG. 3A embodiment. As is shown, core device (62′) comprises a small cylindrical structure, as shown, with opening (48), enclosing a smaller volume (66′) as compared to the core device (62) of dental core and post system 60A. The mid vertical post portion (68′) comprises a cage-like structure formed of struts and/or wires (64) (skin or outer surface not shown), which allows an inner volume (69) to be filled with low-density material. Dental core and post system 60B includes extensions or splines (72) to further transfer, redirect or communicate downwardly directed forces out and away from the vertical axis of the root canal/post.

Although the embodiment described are depicted as comprising one contiguous piece, whether formed as one piece or fixedly and contiguously attached together, the invention is not limited to such a design. That is, it is possible to prefabricate the dental posts in sections, for example, the core device, the mid vertical post section/portion and the post end section/portion, where each of the sections are formed so that they are readily connected together, for example, so they snap together. For example, the connecting portions may include detent means, snaps or may be formed for a friction fit. The connecting portions might also be fabricated to screw or lock into extension radii such as rings to fit into the end dowel/post piece. Such in vivo assembly affords the use of multi variable mix and match sizes.

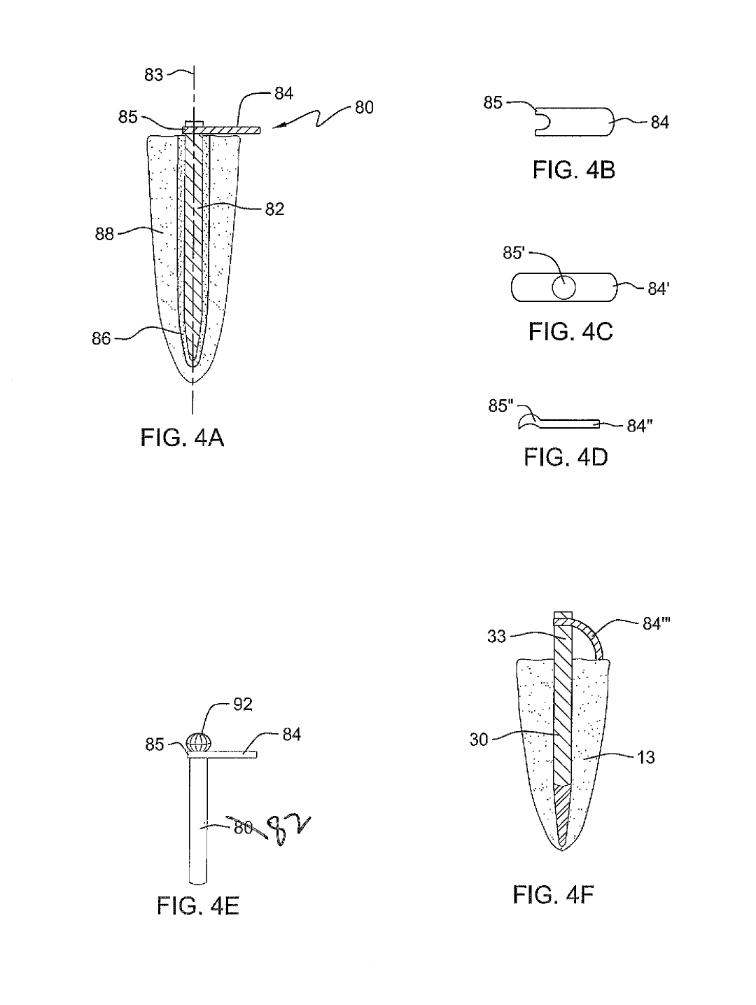

FIG. 4A depicts a dental core system comprising a core device (84), configured as a snap on spline or rib to attach to a dental post or dowel (82). The novel core device (84) is shown after affixation to dental post (82), as system (80). The core device affixes to the dental post at a snap-on end (85), which dental post (82) is shown within a root portion (86) of a tooth remainder surrounded by dentin (88). Another end of the snap-on core device (84) (which is shown separately in FIG. 4b), attaches to or otherwise contacts the tooth remainder or dentin. When attached to post (82) and to the tooth remainder or dentin of the treated tooth, the snap-on core device (84) acts to redirect forces traveling through the post, particularly downward in a direction of vertical axis (83), into dentin or soft tissue in which the snap-on core device is embedded or attached to by the dental practitioner.

While FIG. 4A depicts only one snap-on core device (84) attached to post (82) at snap-on end (85) and to the tooth remainder at its other end, any number of snap on core devices (84) may be attached to the post as required, in any vertical location along the post's vertical axis. Accordingly, and in the spirit of the invention the snap on core device creates an alternative path for, or discontinuity in a path of travel of mechanical, acoustic, vibratory and other energy resulting from occlusal contact. Preferably, these separate snap-on core devices are radially offset from each other about axis (83), for example, with second snap-on core device offset 90 degrees relative the first snap-on core device, a third snap-on core device offset by 180 degrees and a fourth snap-on core device offset by 270 degrees.

The skilled artisan should note, however, that such snap-on core devices are to be attached only where allowable in view of the existing remaining tooth structure. For that matter, these core device need not be “snapped-on” at all, may be fixed to the coronal end of the dental post by any means known to the skilled artisan, as long as same attachment acts to redirect mechanical energy, e.g., vibrations away from the vertical axis, which mechanical energy typically resulting from biting contact with the treated tooth that might otherwise or normally be communicated along the vertical post axis.

FIG. 4C depicts a snap-on core device (84′) that is an alternative embodiment of the snap-on core device (84) of FIGS. 4A, 4B. Snap-on Core device (84′) comprises two struts or wings extending collinearly from a center attaching portion (85′). That is, the snap-on core device (84′) is affixed to a post (82) by center attaching portion (85′), and at its ends to the tooth remainder. The ends of the core device (84′) may be attached to the tooth reminder by any means. For example, the ends may be moulded to set on a rim portion of the tooth remainder, and fixed to same as the core build-up is formed over the coronal post end and body of the core device (85′).

FIG. 4D depicts a snap-on core device (84″) that is yet another alternative embodiment of the core device (84) depicted in FIGS. 4A and 4B. snap-on core device (84″) includes an attaching portion (85″) that has a concavity to be fitted over a ball portion (not shown) of a dental post such that it may snap on and/or be other fixed to the ball portion, e.g., cement. While the snap-on core device embodiments are shown extending substantially perpendicularly out from the vertical post axis, the depictions are meant for exemplary purposes only.

An attachment means may be included for attaching a core device (e.g., a strut or rib) to a dental post, where the other device end connects to or otherwise contacts with the tooth remainder to redirect mechanical forces from the post. The attachment means is configured with a cylindrical portion at its apical end so that it will slide over and attach to the coronal end of the dental post in vivo. The inside diameter of the cylindrical portion the attachment means is larger that an outside diameter of the dental post, and is preferably crimpable to securely attach to the coronal post end. The attachment means, however, is not limited to attachment merely by crimping. The attachment means may be attached to the dental post with a traditional low and/or high density adhesive, with or without crimping.

The core device, e.g., core device 84, may be manufactured so that the attachment means is integral with it, for example, in an extrusion process or an injection molding process. Alternatively, the attachment means may be constructed as a separate device configured to be fixed to the core device using an FDA approved class 1 dental adhesive at manufacture, or constructed as a separate standalone device for connection both the core device and the dental post at use.

The snap-on core devices (84, 84″, 84″) may extend at any angle from 0 to 180 degree from the vertical post axis to contact with and/or attach to the tooth remainder, but preferably between 0 and 90 degrees, and most preferably between 10 and 80 degrees (see, for example, core device 84′″ of FIG. 4F). The struts or appendages, i.e., snap-on core devices engage an outer rim of the root or canal space at angles with the post central vertical axis between 0 and 90 where attached to the post directly. The snap-on core devices, however, are configured or manipulated to extend at about 90 degrees to the vertical post axis if used with (attached to) a core device (12, 12′, 12″, 12″′), such as described above and depicted in FIGS. 1A-1D, or, as another example, quasi-spherical and dome-like core device 92, hereinafter described with reference to FIG. 4E.

FIG. 4E depicts a strut-like core device (84) attached to a post (80) via attaching portion (85) (or other functional attaching means), upon which a second and dome-like core device (92) is attached, or positioned in a restoration. Dome-like core device (92) as shown is constructed as a wire frame, which may or may not be covered with a skin of some type of bio-compatible material. Please note that while constructed as a wire frame, dome-like core device (92) is not limited to a wire or cage-like construction, but may be constructed in any way known to the skilled artisan whereby a low-density inner volume is included. The dome-like core device (92) may be spherical, half spherical, half moon, etc., and preferably including a concavity to attach to a coronal end of a dental post, for example, a ball shaped coronal end.

The inner volume of the dome-like cage structure may be filled with a low-density material such a biocompatible foam or cement, and cured at installation, or may be manufactured to include such a low-density material. Alternatively, the dome-like core device (92) may be formed as a low-density structure without a wire cage, in a spherical shape, half moon shape, half-moon shape with a concave indentation for fixation to a post, etc. In either case, the dome-like core device (92) may be modified physically before affixing to the tooth/post to accommodate a varying shape of a remaining tooth structure.

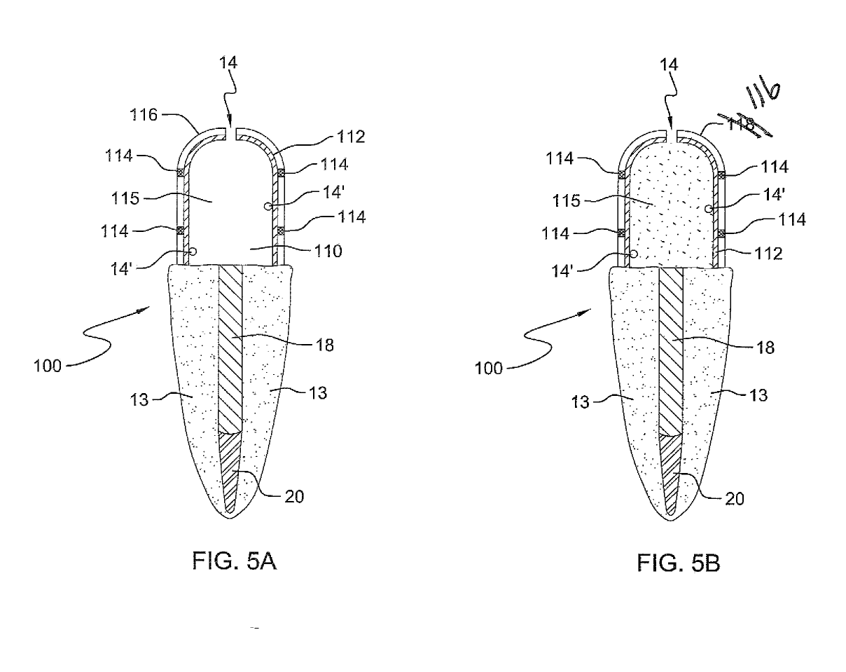

FIGS. 5A and 5B together depict another embodiment of a dental core system (100) of the invention. Dental core system (100) includes a core device (110) with an outer shell (112). The outer shell comprises a high density material. A dental post (18) is shown with both the post and gutta percha fixed within a root canal of a tooth under restoration. The core device is shown in FIGS. 5A and 5B after fixation to post (18) and a tooth remainder or dentin (13). Core device (110) comprises a hollow core or inner volume (115), a low density material fill hole (14), one or more vent holes (14′) and a plurality of skin spacers (114).

The core device is attached in vivo to tooth remainder (13) and dental post (18) at the time of treatment. A skin (116) is shown proximate shell (112), standing off from an outer surface of the shell by an amount defined by the width of skin spacers (114). After attachment, the inner volume (115) of the core device (110) is filled with a low density material (represented by the dotted texture marks in FIG. 5B) by the dental practitioner. During filling, some of the low-density material escapes from vent holes (14′) and fills the space between the outer surface of shell (112) and the skin (116). Alternatively, the space between the outer surface of shell (112) and skin (116) may be filled directly at an opening proximate opening (14). Skin (116) may be clear. After filling, and setting, the set material provides an additional low density flashing on the outer surface of shell (112). The skin may be removed.

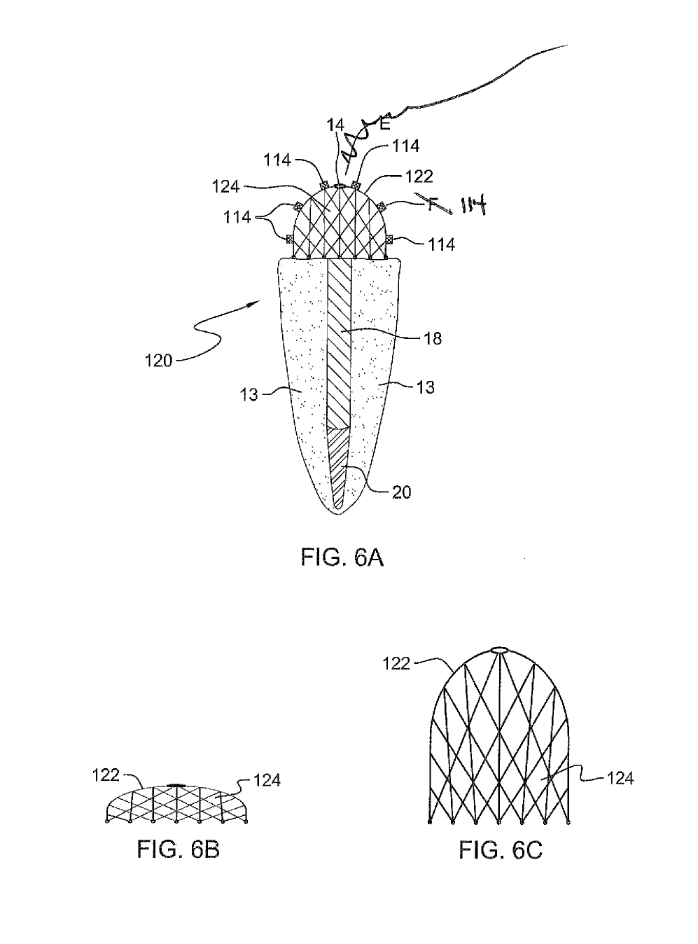

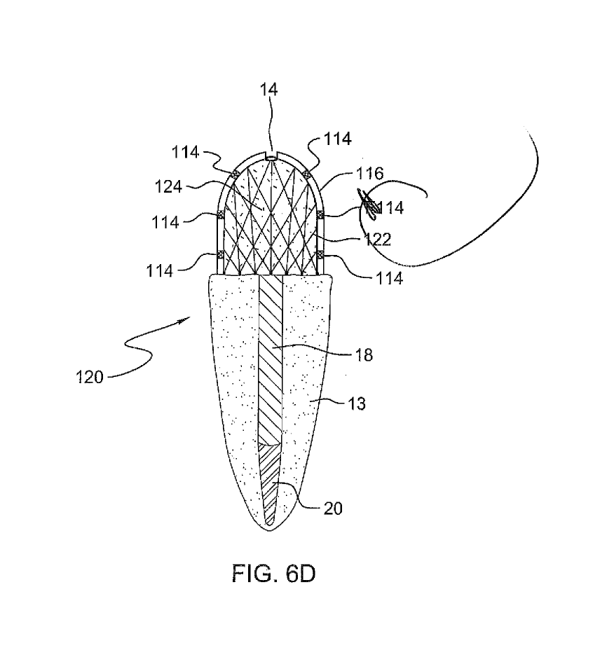

FIGS. 6A and 6B together depict another embodiment of a dental core system (120) of the invention. A dental post (18) is shown attached to the root of an endodontically treated tooth. The core device is shown in FIGS. 6A and 6D after fixation to post (18) and a tooth remainder or dentin (13). Dental core system (120) includes a core device (122) that is expandable from a collapsed position (FIG. 6B). FIG. 6C shows core device (122) in an expanded state, which is the same state of the core device as shown attached in FIG. 6D.

The expandable core device (122) is comprises a set of wires, strands or ribs which slide over each other to expand and contract the physical inner volume of the core device. The physical structure therefore forms a cage-like structure (123), which is expandable and contractible to a desired shape/inner volume. The wires, strands or ribs may comprise metal, reinforced fiber, composites, etc. The cage-like structure (123) of core device (122) comprises a hollow core or inner volume (124), a low density material fill hole (14) and a plurality of skin spacers (114). The core device is attached in vivo to tooth remainder (13) and dental post (18) at the time of treatment.

In FIG. 6D, a skin (116) is shown proximate cage-like structure (123), standing off from an outer surface by an amount defined by the width of skin spacers (114). After attachment, the inner volume (124) of the core device (122) is filled with a low density material (represented by the dotted texture marks in FIG. 6D) by the dental practitioner. During filling, some of the low-density material escapes from the porous nature of the outer cage-like structure (123) and fills the space between the outer surface and the skin (116). Alternatively, the space between the outer surface of cage-like structure (123) and skin (116) may be filled directly at an opening proximate opening (14). Skin (116) may be clear. After filling, and setting, the set material provides an additional low density flashing on the outer surface of (123). The skin may be removed.

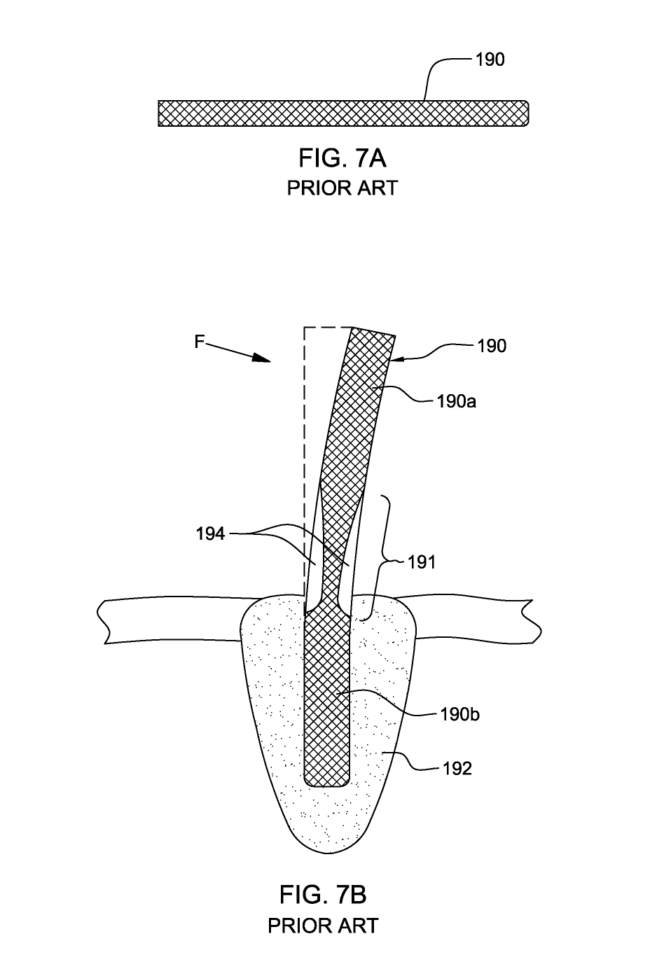

FIG. 7A depicts a fiber reinforced dental post 190, as known in the prior art. And as described in detail above, FIG. 7B depicts a conventional fiber-reinforced post 190 extending out of root 192, wherein the coronal post portion 190a is acted upon by a Force F affecting the portion of the post known as the energy node 191.

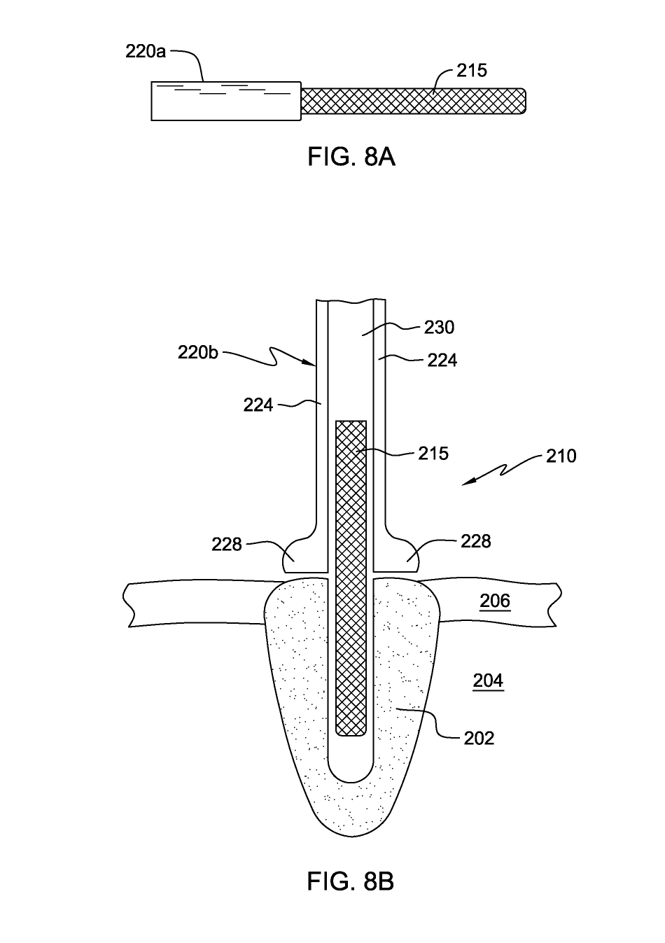

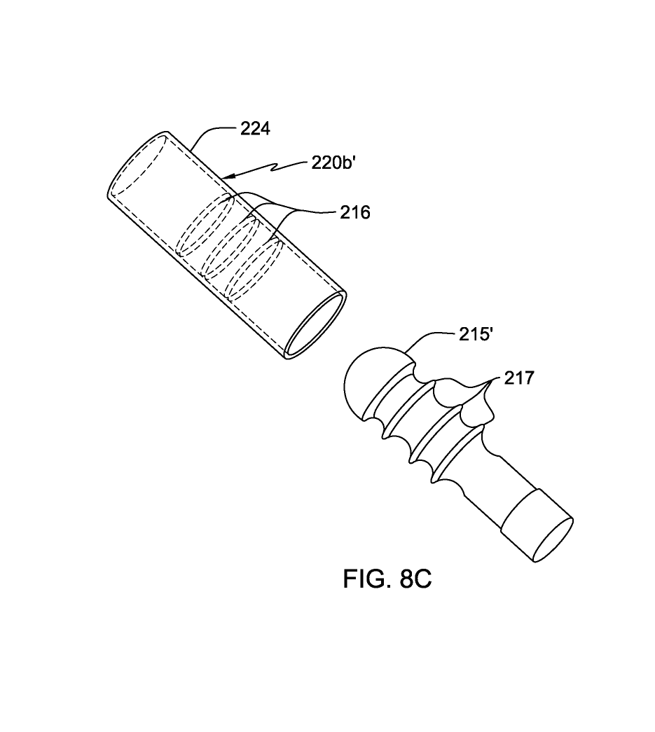

FIG. 8A depicts one embodiment of a hybrid post system of the invention, the system comprising a fiber post 215 with a high density jacket 220a covering one end. The exposed portion of post 215 is intended to be inserted in the root where the jacket 220a and post portion surrounded thereby is intended to operate as a core, extending only to the coronal end of the tooth remainder or root.

FIG. 8B depicts another embodiment of the hybrid dental post system according to the invention. The hybrid dental post system 210 includes a fiber post 215 shown fixed in dentin or tooth remainder (root) 202, which dentin is itself embedded in bone 204 and soft tissue 206. Surrounding fiber post 215 at the portion extending vertically above the tooth remainder 202 is a high-density jacket 220b. The jacket 220b, as distinguished from the jacket 220a depicted in FIG. 8A, comprises a cylindrical sleeve portion 224 and base 228. The base 228, positioned at one end of the sleeve 224, is formed as a radial expansion of the jacket in a form of a platform, as shown. Preferably, a volume of low density cement or other filler material such as a silicone or polyurethane or other resin (Broadly “filler”) 230 are inserted into a cylindrical opening at a coronal end of the sleeve 224, in vivo. Filler 230 essentially operating as an inner core to that area of the inner volume above the coronal end of the fiber post 215 surrounded by sleeve 224 and surrounds post 215 where it is surround by the sleeve 224 and base and where it is fixed in the canal in the root. The filler 203 is low density in order to minimize forces communicated from the core to the fiber and therefore, the center of the root.

In more detail, the jacket 220b, comprising the cylindrical sleeve portion 224 and base 228, is made of metal, a metal oxide such as alumina or zirconia or other from that group, or a metal alloy. The metallic sleeve 224 of jacket 220b surrounds and protects the coronal area of the fiber post 215 (outside the root or dentin 202) in view of the fact that metals and metal alloys readily convey mechanical energy though the sleeve and base into the tooth remainder or dentin 202 and bone 204. That is, any force or energy applied to the coronal portion, i.e., the sleeve 224 above the dentin 202, is transmitted through the metal and into the sides of the tooth rather that down the center of the post and into the root, as is the case with conventional metal post systems.

The root area of a tooth restored using the fiber reinforced root system is protected by mechanical properties of this post system. The systems made from all fiber and resin or all fiber and epoxy absorb and dissipate stress and energy within the system. The modulus of elasticity of fiber reinforced post systems approximate that of tooth structure and prevents the forces from travelling down the center of the root. The compromise is that the coronal area above the root fractures fatigues and fails due to the destructive created energy node inherent in these systems. By definition a node is an area of stress. In many cases fiber reinforced post systems develop stress exceeding the threshold of the materials and the systems fail. This is well documented in the literature.

The inventive hybrid fiber post system is force re-directing because energy is neither transmitted down the center of the root as in conventional metal systems nor concentrated in the post as in fiber post systems. Any mechanical energy or stress applied to the coronal area, i.e., the portion above the dentin of tooth remainder through the use of the hybrid dental post system is communicated or directed to the rim of the residual tooth or root and down the sides of the residual tooth or root directly from the jacketed coronal part, particularly through the platform-like base. This energy that is transmitted away from the coronal area and the center of the root is known to be quite destructive if not redirected.

The hybrid post system features a fiber reinforced post having root portion that, extends into a core area above the tooth remainder or root where it is jacketed in energy redirecting metal or metal alloy or oxides, with the lower part of the fiber post extending into the root. Such a hybrid post system design exhibits the best mechanical properties of metal posts systems and fiber post systems without the concomitant flaws. The jacketed core portion covers the energy node area of the fiber reinforced post that is above the surface of the root (i.e., of sufficient height and width to protect the entire core area of the fiber reinforced post) as well as the inner fiber reinforced post from the insults of fluids, abrasives, flexing, and fiber matrix fatigue. The jacketed core portion is not a flange. The use of a flange would only focus energy to the area just above it and create another destructive energy node. Protection of the energy node of a fiber post needs to be accomplished with jacketing the fiber reinforced post in the core area above the surface where a flanges are located in the prior art.

In the inventive hybrid fiber post system, the energy redirecting jacketed area receives stress or vibrational energy and dissipates it into the sides of the root rim area at the opening of the root canal entrance, preventing such destructive energy from traveling down the post and into the center of the root. The energy redirecting jacketed area further prevents destructive stress from fatiguing and fracturing the fiber reinforced post in its susceptible core area and protects against degradation of the fiber post surface from fluids because micro-movement of the system is also prevented. The fiber reinforced post continues to protect the fiber below root because the mechanical properties of the material shield the root from energy transmission, i.e., keeping the energy in the residual rim of the root. The coronal jacketed component contains a low density resin, epoxy or filler that functions as a binder and energy buffer between the jacketed coronal area and the lower post component.

As mentioned, the coronal portion that jackets the fiber post is made from metals, metal oxides or metal alloys, plastics, and reinforced plastics as distinguished from low density plastics or fiber reinforced plastics. The coronal end or jacket 220A therefore exhibits a high compressive strength found in metals and metal oxides. The jacketed coronal portion (i.e., jacket 220A) is produced by milling, machining, drawing, stamping, dipping, 3D printing or casting.

FIG. 8C highlights that the inner cylindrical surface of the high-density jacket, 220b′, in the sleeve part 224, which contains a connecting means 216 for the fiber reinforced post 215′ that is mated within. The fiber reinforced post 215′ (as shown) is not made from metals, metal oxides, or metal alloys. For that matter, the post 215′ may be made of plastic and does not require fiber reinforced material without deviating from the scope and spirit of the invention.

An ideal low density material would be a silicone elastomer with a density of 1250 kg/m³ or 1.25 g/cm³. High density material is defined as a material with a density greater than 2.00 g/cm³. Alumina ceramics have a density of 2600 kg/m³ or 2.6 g/cm³. Steels are found in a range of 7-8 g/cm³. High Strength material is defined as a material with a compressive strength range greater than or equal to 275 MPa which represents an accepted value for human dentin. Alumina ceramics have a compressive strength of 2100 Mpa. MPa is a Mega Pascal.

In more detail, an outer surface of the fiber reinforced post portion 215′ includes a securing means 217, or some other means for affixing the post and jacket, for mating or cooperating with a respective securing means or detent element 216, located on the inner cylindrical surface of sleeve 224. The jacket (220b, 220b′) and the fiber post (215, 215′) may be connected in the factory or in vivo. If connected in the factory, the upper coronel end of the post or dowel is configured to be long enough to allow the dentist to adjust the length from the terminus end and insuring that the jacketed portion is located in the primary stress point just above the root surface. If mechanically mated in the factory the union could be accomplished by using the same resins or epoxies that bind the fibers in the fiber reinforced root portion. Flexible silicones or urethanes of desired mechanical properties could be used to impart energy dampening and redirecting requirements of this invention.

Since the core energy node area is variable in its dimension due to tooth and force variation, a simple flange as previously described is unacceptable because a simple flange cannot completely clad the energy node and can not focus the destructive stresses down the residual rim of the tooth simultaneously.

If manufactured in two pieces, the jacket 220b and the fiber post 215, the dentist positions the post 215 first and then slides the jacket 220b (cylindrical sleeve 224 and base 228) onto the coronal portion of the post 215 extending vertically out of the root 202. Ideally, the cylindrical sleeve 224 extends 2.5 mm below the contact point of the opposing tooth in vertical height to provide maximum protection for the fiber reinforced post. Ideally, the jacketed portion or cylindrical sleeve 224 has a length in a range of 3 mm to 10 mm and an outer diameter of 2 mm to 4 mm. in an embodiment with a base 228, the base is between 2 and 5 mm. The jacketed coronal part could also be modified with opaque materials used in dentistry to mask the metal color and have modified shapes for different clinical situations.

The length of the fiber reinforced post is preferably between 5 mm and 20 mm, to accommodate most human teeth. The overall length of the assembled hybrid post system is then between 8 mm and 30 mm. The ideal width or diameter of the jacketed coronal part of 1.0 mm to 4 mm. The ID or inner diameter of the sleeve/base is between 0.85 mm and 3.0 mm, such that the wall thickness of the jacket is between 0.4 mm and 2.5 mm. The ideal range of widths or diameters of the fiber reinforced post part is 0.75 mm to 2.0 mm.

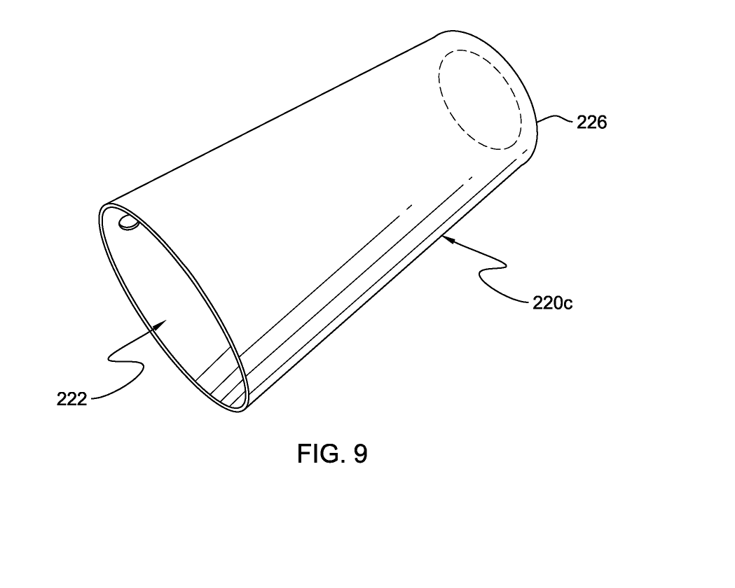

FIG. 9 depicts one embodiment of a jacket 220c for attachment to the upper coronal end of a fiber post 215, in vivo. An open end 222 of the jacket 220c is formed with a larger cylindrical radius than that of the closed upper (coronal) end 226. The coronal end of a post or dowel 215 (not shown in FIG. 9) is inserted and seated against end 226. This is advantageous because taper provides more room for dental restoration to allow a more life-like appearance to porcelain and other restorative materials. Also, being tapered, the jack 220c (at least the coronal end) is able fit into a tighter space between teeth.

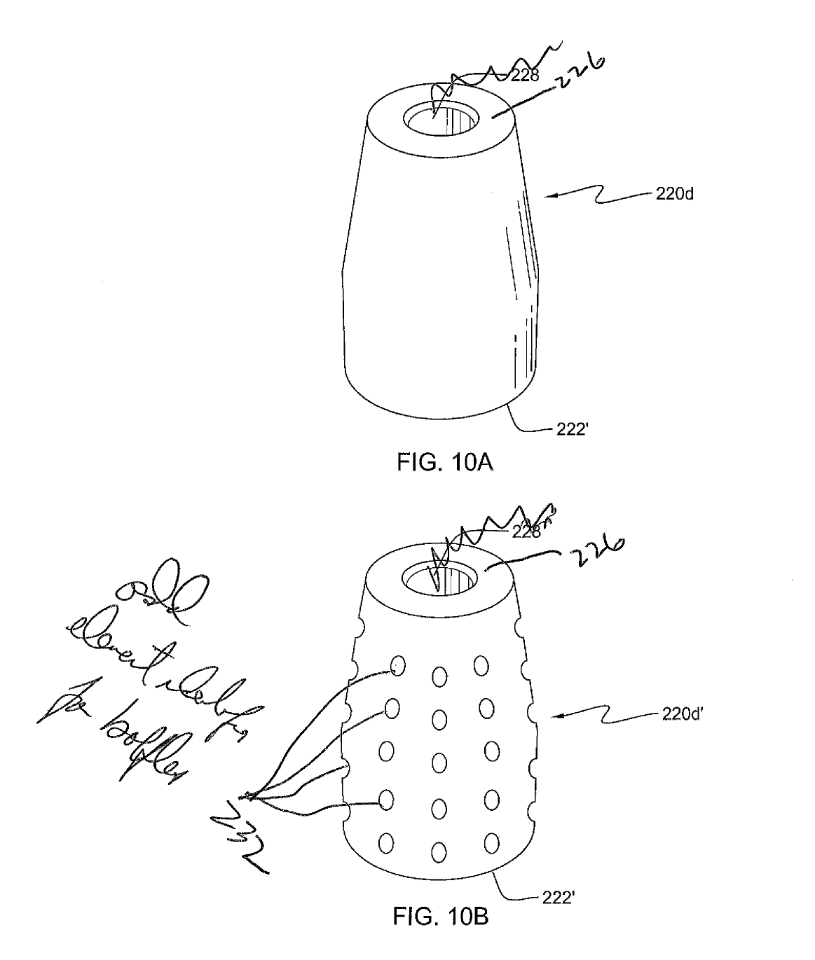

FIG. 10A depicts an embodiment of a high-density jacket 220d formed as a tapered cylinder for attachment to the upper coronal end of a fiber post or dowel 215, in vivo. Jacket 220d, however, is tapered from its open end 222′, which has a larger cylindrical radius than that of the closed upper (coronal) end 228. The embodiment 220d′, as shown in FIG. 10B, includes openings 232 through the shell (i.e., the high-density jacket), allowing fluid communication from outside to the inner cylindrical volume. Please note that the embodiments shown also have a smaller inner radius resulting in a great amount of material. That is, the shell is thicker than the jacket 220c shown in FIG. 9. The coronal end of a post 215 (not shown in FIGS. 10a and 10b) is inserted and may extend through the opening at end 228, as shown. This is advantageous because it allows a post component to be inserted through or resin pumped into the inner volume.

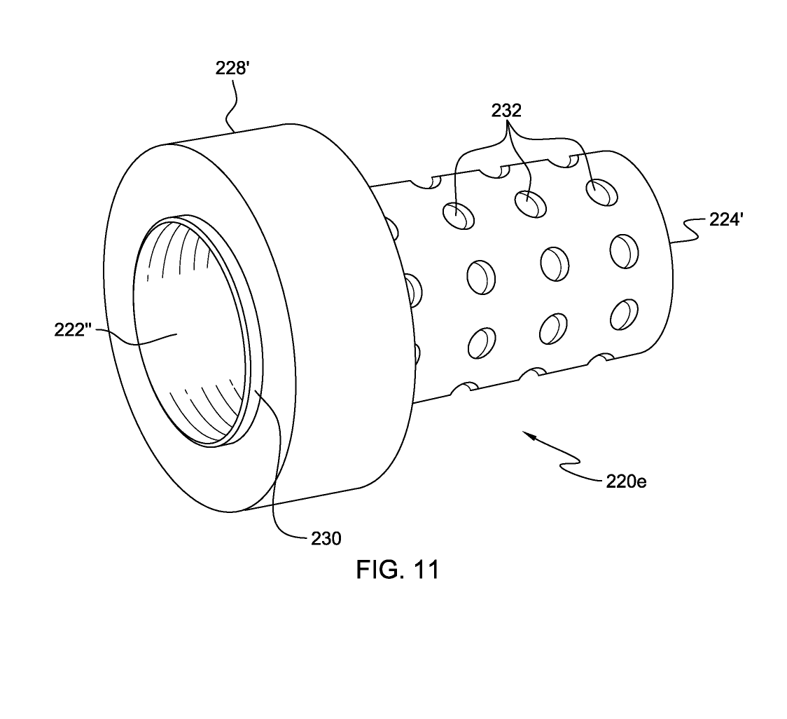

FIG. 11 depicts one embodiment of a jacket 220e formed with a cylindrical stabilizing skirt-like extension 230, which extends into the root and attaches to the portion of the fiber post 215 thereat. In more detail, during use the lower open end 222″ is slipped over the coronal end of a post or dowel (not shown in FIG. 11), which preferably extends at least as far as the coronal end 224′ of the high-density jacket. Where necessary, the coronal end of the dowel may extend beyond end 228′ of jacket 220e. Baffles 232 are included to provide more mechanical retention. This skirt 230 and widened base 228′ allow the addition of a greater volume of low density to the system.

The cylindrical sleeve 220e is tube-like in its most basic embodiment but may include a simple or complex energy baffle that enables greater energy distribution away from the root center (see FIGS. 10 and 11). The widened base 228′ in the jacketed portion 220e creates a platform to allow contact with the root and prevent the jacket 220e from entering the canal to any greater extent that the length of the stabilizing extension or skirt 230. If this occurs a wedging effect would result and violate the spirit of this invention. This skirt and widened base allow the addition of a greater volume of low density to the system.

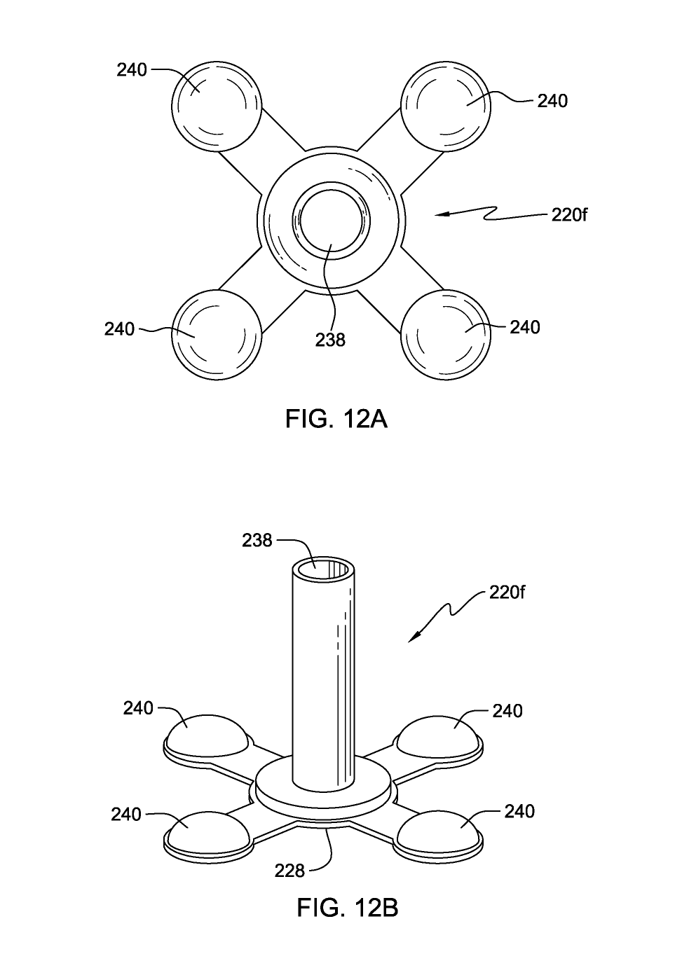

FIG. 12A depicts one embodiment of a jacket 220f for attachment to the upper coronal end of the inventive dental post system that includes four (4) 4 splines 240 extending from the radial center for fixation to portions of the tooth remainder. FIG. 12B is a perspective view of the FIG. 12A embodiment. The coronal end of a post or dowel 215 (not shown in FIGS. 12A and 12B) is inserted into and through opening 238, an amount of which is determined by the clinician. This is advantageous because the splines provide paths formed by a high density material from the jacket 220f to the tooth remainder, which paths are in addition to the path realized by connection of the base 228 to the tooth remainder.

In more detail, the coronal or lower part of the jackets 220a-f, that connect to the lower root portion of the fiber post 215 is fabricated from stainless steel tubing. Preferably, the stainless steel tubing is common tubing know for use in hypodermic needles and syringe tips (see details below). The wall thickness of the jacket, i.e., a thickness of its tubular shell defines an amount of force that the jacket and therefore the hybrid post system can withstand. The length and outer diameter of the lower end portion (configured to be larger that the upper end) also affects the amount of forces the jacket and therefore the hybrid post system can withstand. Varying the metal and metal alloys used to form the jacket also affects the amount of forces jacket and therefore the hybrid post system can withstand.

The jacket may be formed by cold stamping or metal injection molding to account for distinct shapes for the baffles, which baffles protect the node region. The length of the tubing is adjustable, i.e., cut to length and swaged on one end using cold or hot metal working techniques to create the desired platform height and width that defines the base of the coronal part of the device. The skilled artisan should recognize that other shaping and forming techniques known to the trade could be employed

If the jacket is made of high density ceramics, it must be formed as a hollow tube of alumina or zirconium or similar metal oxide materials. The metal oxide materials for same are chosen with the desired internal diameter. Then using known micro-machining techniques such ad grinding, laser, water laser and others, the desired platform defining the base the other optional baffles could be created by reduction.

Preferably, the jacket made of high density ceramic material is formed with micro pores, a rough surface, annular rings etc., in order to increase retention of cements, adhesives and/or core filler materials along the outer surface and on any portion of the inner cylindrical surface which is affixed to the outer surface of the post. In one embodiment, the jacket made of high density ceramic material has an outer diameter of between 2.0 mm and 3.5 mm, preferably 2.5 mm and an inner diameter of between 0.9 mm and 2.9 mm, preferably 1.60 mm. This would accommodate a post between 1.0 mm and 2.7 mm or 2.8 mm, preferably 1.5 mm. Such post would fit inside the inner jacket volume leaving an inner volume of low density material to surround post. The post extends into the root and into the apical end of the jacket, to make contact with the root surface and, at least as far as the vertical or axial extent of the base portion in the coronal direction.

The following table (Table 1) identifies a number of common post outer diameters in inches and mms

TABLE 1
Outer diameter of common fiber posts

| | |
|---|---|
| .036″ | 0.90 mm |
| .040″ | 1.00 mm |
| .045″ | 1.14 mm |
| .050″ | 1.25 mm |
| .055″ | 1.40 mm |
| .060″ | 1.50 mm |
| .070″ | 1.75 mm |

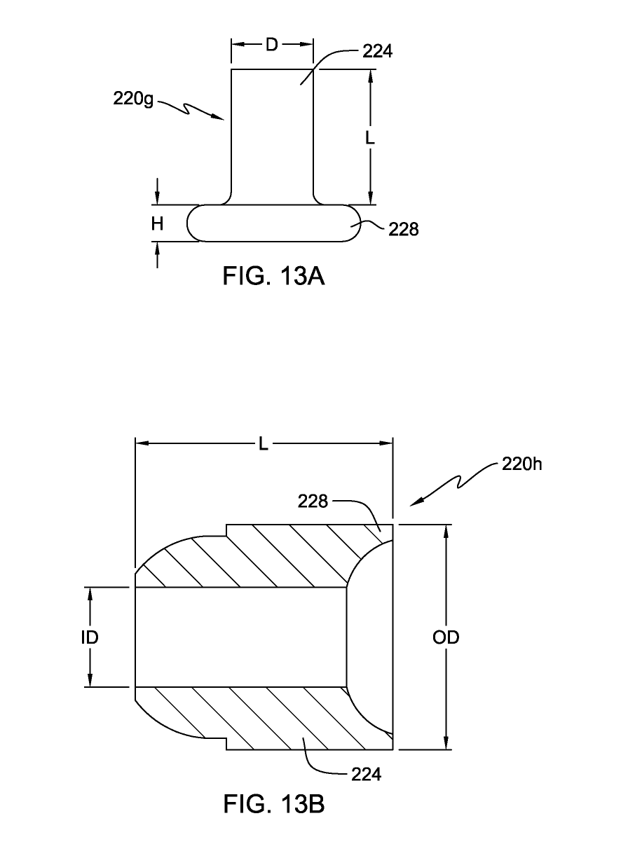

Accordingly, for a jacketed post and core device with a 5 mm long jacket described here the volume of low density material inside would be 1.22 mm³. If a smaller diameter post of 1.0 mm is used with the same 5 mm long jacket a larger low density volume of 6.13 mm³ would be created. This nuance allows for the dentist to choose a favored clinical option. The embodiment of FIG. 13B shows a flared splined base that allows even more low density volume. The low density can be further increased to better mimic the natural tooth pulp organ by using only a filler instead of a post

The jacket section could be connected to the post in the factory using curing light, dual part resins, epoxies, heat etc. or by the dentist in vivo. A preferred manufacturing technique attaches the fiber reinforced post in a pre-peg of partially assembled state to the jacket incorporating the unfilled matrix of the fiber post as the inner low density volume of the device. For example, in one embodiment, the jacket length is 5 mm and the length of the post extending from the base is 15 mm. The 15 mm post end is adjustable by the dentist to essentially fit all teeth. The jacketed end is also machinable by the dentist.

Alternative embodiments of high-density jackets 220g, 22h of the hybrid core and post system of the invention are depicted in FIGS. 13A and 13B, respectively. in the jackets therein, a width diameter is the outer diameter of the widest part of the platform 228. The jacket preferably is machined to 2.5 mm diameter from a larger diameter of stock ceramic tubing. For example, if a 3.2 mm outer diameter tube that is 7 mm long is machined on a rotary lathe or other subtractive machine to a depth of 0.35 mm for a distance of 5 mm, this would create a 2.5 mm by 5 mm long outer diameter tube in the upper portion with a 3.2 mm by 2 mm outer diameter platform. Such dimensions are preferred as they would likely accommodate the most teeth, on average.

To create a tube with an outer diameter wider than needed is selected and then machined to a narrow diameter leaving the inner diameter the same. The H height is a minimum of 1.0 mm to cover the energy node as previously detailed. The L height is ideally 6 mm. The inner diameter for the preferred size of each must accommodate a 1.25 mm post: so D diameter is the outer diameter that incorporates the post+the wall thickness+the buffer space around the post. Using Table 2, below, alumina oxide tubing with an inner diameter of 1.62 mm can accommodate a post of at least 1.25 mm. That is, a post with an outer diameter of 1.25 mm will readily slide into the inner volume of the alumina oxide jacket with the 1.62 mm inner diameter a circumferential 0.185 mm gap around the post.

The net volume of the low density volume for this embodiment becomes π[r²][L+H] of the ID−π[r²] [L+H] of the post. For the embodiment chosen here with a total height of 7 mm the net low density volume is 5.85 mm³. If no post is used in the system, for example, the net low density volume is merely 3.14 r² h, where r is the radius of the ID of the device and h is the height of the tube. This does not include the volume of the root canal space of the roots.

TABLE 2
(Common Alumina tube sizes)

| | | |
|---|---|---|
| Outer Diameter | Inner Diameter | wall thickness = |
| Millimeters-Inches | mm | OD-ID/2 inches |

| | | | |
|---|---|---|---|
| .8 mm | .031″ | .5 mm | .020″ |
| 1.6 mm | .062″ | .8 mm | .031″ |
| 3.2 mm | .125″ | 1.6 mm | .062″ |
| 4.0 mm | .156″ | 2.4 mm | .094″ |
| 4.8 mm | .187″ | 1.6 mm | .062″ |
| 4.8 mm | .187″ | 2.4 mm | .094″ |
| 6.4 mm | .250″ | 3.2 mm | .125″ |

Jackets 220 also may be formed from alumina oxide ceramic material manufactured by Thermo Shield, Portola Valley, Calif., and depicted as jacket 220H in FIG. 13B. Therein, sleeve portion 224 ends in a spline or base 228, which operates at the apical end of the jacket as a full spline. That is, the shape of the base or spline 228 as shown (FIGS. 13A, 13B) develops with 360 degrees of contact leaving an increased volume for low density material. The jackets may come in various sizes. For example, for smaller teeth, the jacket 220H may have an outer diameter (OD) as 0.090 inch, inner diameter (ID) as 0.040 inch and a length of 0.125 inch, for medium sized teeth, the jacket 220G may have an OD of 0.170 inch, and ID of 0.065 inch and a length of 0.188 inch and for larger teeth an OD of 0.33 inch, and ID 0.133 inch and a length of 0.313 inch.

Alternatively, the jacket 220 may comprises tubular stainless steel or other high density metal with equivalent inner diameters comparable to those of the embodiments formed with the high density metal oxides. In the metal jackets, the wall thickness may be thinner than the ceramic oxides previously discussed. Traditional sizes for hypodermic syringe tubing are in Table 3, which is derived from New England Small Tube Corporation, Litchfield N.H.

TABLE 3

| Gauge | Outside Diameter | Wall | Inside Diameter |
|---|---|---|---|
| Size | (inches) | (inches) | (inches) |
| 6 | 0.203 | 0.015 | 0.173 |
| 7 | 0.180 | 0.015 | 0.150 |
| 8 | 0.165 | 0.0155 | 0.135 |
| 9 | 0.148 | 0.015 | 0.118 |
| 10 | 0.134 | 0.014 | 0.106 |
| 11 | 0.120 | 0.013 | 0.094 |
| | 0.120 | 0.010 | 0.100 |
| 12 | 0.109 | 0.012 | 0.085 |
| | 0.109 | 0.009 | 0.091 |
| 13 | 0.095 | 0.012 | 0.071 |
| | 0.095 | 0.009 | 0.077 |
| | 0.095 | 0.005 | 0.085 |
| 14 | 0.083 | 0.010 | 0.063 |
| | 0.082 | 0.008 | 0.067 |
| | 0.083 | 0.0055 | 0.072 |
| 15 | 0.072 | 0.009 | 0.054 |
| | 0.072 | 0.006 | 0.060 |
| | 0.072 | 0.005 | 0.0625 |
| 16 | 0.065 | 0.009 | 0.047 |
| | 0.065 | 0.006 | 0.0535 |
| | 0.065 | 0.005 | 0.0555 |
| 17 | 0.058 | 0.008 | 0.042 |
| | 0.058 | 0.005 | 0.0475 |
| | 0.058 | 0.004 | 0.050 |
| 18 | 0.050 | 0.0085 | 0.033 |
| | 0.050 | 0.006 | 0.0385 |
| | 0.050 | 0.004 | 0.042 |
| 19 | 0.042 | 0.075 | 0.027 |
| | 0.042 | 0.005 | 0.0325 |
| | 0.042 | 0.0035 | 0.035 |
| 20 | 0.036 | 0.006 | 0.024 |
| | 0.095 | 0.005 | 0.026 |
| | 0.095 | 0.004 | 0.028 |
| 21 | 0.032 | 0.006 | 0.020 |
| | 0.032 | 0.0045 | 0.023 |
| | 0.032 | 0.0035 | 0.025 |
| 22 | 0.028 | 0.006 | 0.016 |
| | 0.028 | 0.004 | 0.020 |
| | 0.028 | 0.003 | 0.022 |
| 23 | 0.025 | 0.006 | 0.013 |
| | 0.025 | 0.004 | 0.017 |
| | 0.025 | 0.003 | 0.019 |
| 24 | 0.022 | 0.005 | 0.012 |
| | 0.022 | 0.004 | 0.0145 |
| | 0.022 | 0.003 | 0.016 |
| 25 | 0.020 | 0.005 | 0.010 |
| | 0.020 | 0.004 | 0.012 |
| | 0.020 | 0.003 | 0.014 |
| 26 | 0.018 | 0.004 | 0.010 |
| | 0.018 | 0.003 | 0.012 |
| | 0.018 | 0.002 | 0.014 |
| 27 | 0.016 | 0.004 | 0.008 |
| | 0.016 | 0.003 | 0.010 |
| | 0.016 | 0.002 | 0.012 |

Hypodermic syringe tubing makes a good raw material to create the jacket to fit over the fiber post. The dental practitioner merely secure the tube size with an outer diameter that is able to fit into the root and an inner diameter that is able to accommodate the outer diameter of the fiber post to be implanted. Then, the length of tube is cut individually or the fiber post pre peg wire could be threaded along a long length of metal tubing and cut to preferred lengths after curing the fiber resin material of the post component. Another method is to crimp the desired length of metal jacket around a section of cured or uncured fiber post material leaving the desired exposed length of post and desired length of the jacketed portion. The inner low density volume could be altered by using more or less low density material inside the tubing.

Alternatively the dental practitioner can select metal jackets in vivo and adjust the inner low density volume, post length, jacket length and diameter using drills and other machining means. No post could be used to provide a maximum volume of low density material inside of the jacketed core. A partial tube of 180° could be fabricated to fit different tooth shapes. The tube in all of its forms and the other wire or cage type embodiments could be manufactured directly to the post to create the jacketed core component. Where platform 228 of the metal jackets 220 is widened (for example, as shown in the embodiments depicted by FIGS. 8B, 10A, 10B and 11), the platform is created as a continuous integral part of the upper tube or sleeve 224 by swaging and stamping techniques to increase the width of the outer diameter of the selected tube from the chart below

The thicker the wall thickness the wider and taller the platform must be. For example a tube with a wall thickness of 0.55 mm and ID of 1.1 mm and OD of 1.65 mm will yield a widened platform of approximately 2.4 mm in diameter and 0.55 mm vertical height. These specifications could be changed by starting with a thicker wall which would increase the platform height. Electronic welding and other techniques could be employed to change the platform height and width by addition. The platform in all embodiments could be adjusted to increase its vertical height or enter the root slightly when varying amounts of tooth structure are present to cover the energy node. It is important to note that creating these devices could also be accomplished with three dimensional printing, triaxial milling and injection molding techniques.

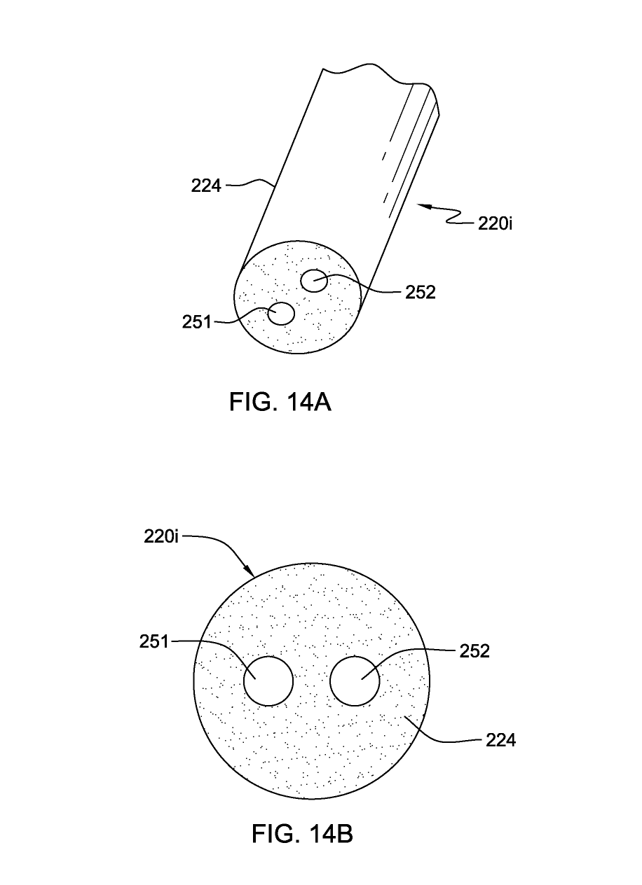

FIGS. 14A and 14B depict another embodiment, wherein the prefabricated jacket 220i of hybrid dental post and core system has is no platform 228 but merely comprises a cylindrical sleeve or tube 224 (similar to the device depicted in FIG. 8A above). This sleeve or tube 224 can have at least one inner cylindrical bore or barrel. For a bicuspid tooth with two canals, a double barrel tube (with two respective bores 251, 252) is essentially creates two low density chambers. This could be a partial tube that is only 180° or any amount to substantially fit the form of root canal treated teeth. The tube 224 in all of its shapes could be formed into the body of the post to provide the jacketing effect.

All of the embodiments described herein replace the human low density pulp organ artificially while simultaneously restoring the tooth back to function and protecting the tooth and system from failure.

Although examples of the invention have been shown and described, it would be appreciated by those skilled in the art that changes may be made in these embodiments without departing from the principles and spirit of the invention, the scope of which is defined in the following claims and their equivalents.

1. A prefabricated, hybrid dental pulp organ replacement system, comprising:
a tube-like core device formed as a substantially cylindrical sleeve of a high-strength, high-density material that surrounds an inner volume, the inner volume comprising a low-density, low strength material, wherein the cylindrical sleeve has a coronal end and an apical end, wherein the apical end is formed as a non-compressible platform with a radial expansion and wherein the apical end is configured to be fixed to a tooth remainder or root of a tooth under restoration; and
a dental post including an apical portion that is positioned in an inner volume of a root cavity of the tooth and a coronal portion that is positioned slightly above a cemento-enamel junction of the tooth;
wherein the high density cylindrical sleeve redirects mechanical forces imposed on the core into a root periphery of to prevent said forces from traveling along an axial center of the dental post positioned in the root while protecting at least the coronal portion of the dental post and the low density inner volume of the core device, surrounded by the cylindrical sleeve from deleterious forces and fluids.

2. The prefabricated, hybrid dental pulp organ replacement system as set forth in claim 1, wherein the low-density, low strength material displays a density of greater than 0.01 g/cm³ and less than the density of dentin.

3. The prefabricated, hybrid dental pulp organ replacement system as set forth in claim 1, wherein the high-strength, high-density material displays a compressive strength of greater than or equal to compressive strength of dentin.

4. The prefabricated, hybrid dental pulp organ replacement system as set forth in claim 1, wherein dental post comprises a fiber-reinforced post.

5. A prefabricated hybrid dental post and core system comprising:
a non-metallic low density post with a coronal end and apical end; and
a jacket comprising a rigid, high density material with a non-compressible platform portion formed as a radial expansion and an opening in a lower end or base, the jacket configured for receiving the coronal end of the post in order to form a high density core component with the platform portion in the lower end surrounding the non-metallic low density post in order to prevent bending of the coronal portion of the post surrounded thereby;
wherein the jacket is attached at the apical end to a periphery of a tooth in which the system is used just above a tooth root; and
wherein the high density core component redirects mechanical forces imposed thereon to the periphery of the root of the tooth to keep the forces away from an axial center of the root while protecting the portion of the fiber post surrounded by the jacket from deleterious forces and fluids.

6. The prefabricated hybrid dental post and core system of claim 5, wherein the jacket comprises any of the group consisting of metal, metal alloy and metal oxide.

7. The prefabricated hybrid dental post and core system of claim 5, wherein the apical end of the post extends into the axial center of the root and the lower end of the jacket is conjoined to the coronal end of the post.

8. The prefabricated hybrid dental post and core system of claim 5, wherein the post and jacket are attached to each other with any of the group consisting of resin, epoxy, silicone, urethane or variations of these.

9. The prefabricated hybrid dental post and core system of claim 5, wherein the post comprises plastics, reinforced plastics or composites.

10. The prefabricated hybrid dental post and core system of claim 5, wherein the jacket is formed as a cylindrical shell.

11. The prefabricated hybrid dental post and core system of claim 10, wherein an outer diameter at the lower end of the cylindrical shell has is larger than an outer diameter at the upper end forming a taper between the upper and lower ends.

12. The prefabricated hybrid dental post and core system of claim 5, wherein the jacket includes at least one baffle.

13. The prefabricated hybrid dental post and core system of claim 12, wherein the energy re-directing baffle comprises at least one circumferential.

14. The prefabricated hybrid dental post and core system of claim 12, wherein the energy re-directing baffle comprises at least one spline.

15. The prefabricated hybrid dental post and core system of claim 12, wherein the energy re-directing baffle comprises a circumferential rim.

16. The prefabricated hybrid dental post and core system of claim 5, wherein the jacket is formed as a tube, wherein a diameter of the lower end of the jacket forms a ring-like gap between an outer surface of the post and an inner surface of the jacket in which low density material is contained.

17. The prefabricated hybrid dental post and core system of claim 16, wherein the jacket is formed with at least one energy redirecting baffle on its external surface.

18. A tooth restorative system comprising a prefabricated chambered core component formed with a high density material and configured as a cylindrical shell with a coronal end and a base end, wherein the base end includes at least one spline extending therefrom to the root of a tooth, up to the base, and wherein a filler comprising a low density flowable material is provided through an opening in the coronal end to fill any void in the canal and an inner cylindrical volume of the cylindrical shell thereby preventing surface contact between the post and the cylindrical shell and wherein mechanical forces imposed on the prefabricated core component are redirected away from an axial center of the root into the root periphery.

19. The device in claim 18, where the spline is continuous with the apical portion of the high density core covering the root periphery and forming a tapered hollow chamber with its widest diameter at its base.

20. The tooth restorative system as set forth in claim 18, wherein low density, high strength fibers are inserted into any void in the canal and the inner volume prior to filling.

21. A hybrid dental post system comprising:
a non-metallic post with a coronal end and apical end; and
a jacket with an upper end and a lower end, the lower end comprising a non-compressible platform portion formed as a radial expansion and an opening into which the coronal end of the post extends and is protected by the lower end of the jacket to prevent damage to the post from bending forces when the apical end of the post is extended into a canal in a tooth under restoration, the lower end of the jacket attached to the tooth and a core is constructed about the jacket; and
wherein forces imposed on the core are redirected by the jacket away from an axial center or root and bending of the post portion protected by the jacket is avoided.

22. The system of claim 21, wherein the post comprises fiberglass reinforced plastic or plastic composites.

23. The system of claim 21, wherein the Jacket includes at least one energy re-directing spline.

24. The system of claim 21, wherein the lower end of the jacket comprises a base in a form of a circumferential rim.
